(19) United States
(12) Patent Application Publication
(10) Pub. No.: US 2012/0149840 A1
(43) Pub. Date: Jun. 14, 2012

(54) PROCESS FOR PRODUCING AN AQUEOUS POLYMER DISPERSION

(75) Inventors: Kevin Müller, Heppenheim (DE); Ulrich Berens, Binzen (DE); Hans J. Schanz, Statesboro, GA (US)

(73) Assignees: Univ. of Southern Mississippi Res. Foundation, Hattiesburg, MS (US); BASF SE, Ludwigshafen (DE)

(21) Appl. No.: 13/311,965

(22) Filed: Dec. 6, 2011

Related U.S. Application Data
(60) Provisional application No. 61/420,795, filed on Dec. 8, 2010.

(51) Int. Cl. C08L 23/24; C08F 2/16; C09D 123/24; C07F 15/00; C08F 36/20; C09J 123/24

(52) U.S. Cl. 524/836; 526/283; 548/103; 546/2

(57) ABSTRACT

Polymerizing an ethylenically unsaturdated monomer in an aqueous medium can produce an aqueous polymer dispersion. The polymerization is in the presence of a dispersant and a metal-carbene complex. The polymerization can also optionally be in the presence of a dispersant, an organic solvent with low solubility in water, or both. The aqueous polymer dispersion resulting from the process can be used to make a polymer powder.

The present invention relates to a process for producing an aqueous polymer dispersion by polymerization of at least one ethylenically unsaturated monomer MON in an aqueous medium in the presence of at least one dispersant DP, optionally an organic solvent OS which has a low solubility in water and at least one metal-carbene complex C of the general formula (I),

MX¹X²L¹L²L³[=CR¹R²] (I),

where
M is Os, Mo, W or Ru in the oxidation states +II, +III, +IV or +VI,
X¹, X² are each, independently of one another, halide, pseudohalide, alkoxide, acetate, sulfate, phosphate,
L¹, L², L³ are each, independently of one another, 1,3-bis(C₁-C₅-alkyl)imidazolidin-2-ylidene, 1,3-bis(aryl)imidazolidin-2-ylidene, 1,3-bis(2,4,6-trimethylphenyl)-imidazolidin-2-ylidene, 1,3-bis(2,4,6-tri-C₁-C₅-alkylphenyl)imidazolidin-2-ylidene, 1,3-bis(2,4-diisopropylphenyl)imidazolidin-2-ylidene, 1,3-bis(2,4-di-C₁-C₅-alkylphenyl)imidazolidin-2-ylidene, 1,3-bis(2,6-diisopropylphenyl)-4,5-imidazolin-2-ylidene, 1,3-bis(2,6-diisopropylphenyl)imidazolidin-2-ylidene, 1,3-bis(2,4,6-tri-C₅-C₈-cycloalkylphenyl)imidazolidin-2-ylidene, 1,3-bis-(C₁-C₅-alkyl)imidazolin-2-ylidene, 1,3-bis(aryl)imidazolin-2-ylidene, 1,3-bis-(2,4,6-trimethylphenyl)imidazolin-2-ylidene, 1,3-bis(2,4,6-tri-C₁-C₅-alkyl-phenyl)imidazolin-2-ylidene, 1,3-bis(2,4-diisopropylphenyl)imidazolin-2-ylidene, 1,3-bis(2,4-di-C₁-C₅-alkylphenyl)imidazolin-2-ylidene, 1,3-bis(2,4,6-tri-C₅-C₈-cycloalkylphenyl)imidazolin-2-ylidene, 3-bromopyridine, 3-chloro-pyridine, 3-fluoropyridine, 2-dimethylaminopyridine, 3-C₁-C₅-alkylpyridine, di-C₁-C₂₀-alkyl ether, di-C₃-C₂₀-cycloalkyl ether, 2-isopropoxyphenyl-methylene, 2-isopropoxypyridine, triarylphosphine, tri-C₅-C₈-cycloalkyl-phosphine, tri-C₁-C₅-alkylphosphine or diaryl-C₁-C₅-alkylphosphine, and
R¹, R² are each, independently of one another, hydrogen, C₁-C₂₀-alkyl, C₂-C₂₀-alkenyl, C₄-C₈-cycloalkenyl, C₂-C₂₀-alkynyl, aryl, indenyl, 2-isopropoxyphenyl, 2-isopropoxy-5-(2,2,2-trifluoroacetamido)phenyl, C₁-C₂₀-alkoxyphenyl, C₁-C₂₀-alkoxyamino, C₁-C₂₀-alkoxy, C₁-C₂₀-alkoxycarbonyl, C₂-C₂₀-alkenyloxy, C₂-C₂₀-alkynyloxy, aryloxy, C₁-C₂₀-alkylthio, arylthio, C₁-C₂₀-alkylsulfonyl, C₁-C₂₀-alkylsulfinyl or together form a radical [═CR³R⁴], where R³ and R⁴ are each, independently of one another, hydrogen, C₁-C₂₀-alkyl, C₂-C₂₀-alkenyl, C₂-C₂₀-alkynyl, aryl, indenyl, isopropoxyphenyl, C₁-C₂₀-alkoxyphenyl, C₁-C₂₀-alkoxyamino, C₁-C₂₀-alkoxy, C₁-C₂₀-alkoxycarbonyl, C₂-C₂₀-alkenyloxy, C₂-C₂₀-alkynyloxy, aryloxy, C₁-C₂₀-alkylthio, arylthio, C₁-C₂₀-alkylsulfonyl, C₁-C₂₀-alkylsulfinyl,
   where
   the alkyl radicals of the groups L¹, L², L³, R¹, R², R³ and R⁴ in general may optionally be substituted by 1, 2 or 3 groups selected from among C₁-C₅-alkyl, aryl, halogen, hydroxy, mercapto, C₁-C₅-alkoxy and C₁-C₅-alkoxy-carbonyl, aminooxy, hydrazino, carboxy, carboxyamido, acetamido, amino, nitro, cyano, sulfamoyl, amidino, hydroxycarbamoyl, carbamoyl, phosphonamino, hydroxyphosphinoyl, phosphono, sulfino, sulfo, dithiocarboxy, thiocarboxy, furyl, pyridinyl, piperidinyl, furfuryl, pyrazolyl, isothiazolyl, pyrazinyl, pyrimidinyl, pyridazinyl, isoindolyl and indolyl, and the aryl radicals of the groups L¹, L², L³, R¹, R², R³ and R⁴ may optionally be substituted by 1, 2 or 3 groups selected from among C₁-C₅-alkyl, aryl, halogen, hydroxy, mercapto, C₁-C₅-alkoxy and C₁-C₅-alkoxycarbonyl, hydrazino, carboxy, carboxyamido, acetamido, amino, nitro, cyano, sulfamoyl, amidino, hydroxycarbamoyl, carbamoyl, phosphonamino, hydroxyphosphinoyl, phosphono, sulfino, sulfo, dithiocarboxy, thiocarboxy, furyl, pyridinyl, piperidinyl, furfuryl, pyrazolyl, isothiazolyl, pyrazinyl, pyrimidinyl, pyridazinyl, isoindolyl and indolyl,

with the proviso that at least one of the groups L¹, L², L³, R¹, R², R³ and R⁴ is substituted by at least one group selected from the group consisting of carboxylate (—CO₂Z), sulfonate (—SO₃Z), ammonium (—NABCD), phosphate (—PO₃Z), phosphonium (—PABCD), imidazolylium (-imidazolylAD), pyridylium (-pyridylAD), piperidylium (-piperidylABD), pyrylium (-pyryliumD), pyrazolylium (-pyrazolylAD), isothiazolylium (-isothiazolylAD), pyrazinylium (-pyrazinylAD), pyrimidinylium (-pyrimidinylAD) or pyridazinylium (-pyrazinylAD) which can be dissociated ionically in the aqueous reaction medium under polymerization conditions,

where

Z is a proton, an alkali metal cation or ammonium,

A, B, C are each, independently of one another, hydrogen, C₁-C₅-alkyl, aryl and

D is an anion,

or a methylene group in at least one of the C₅-C₈-cycloalkyl groups of the tri-C₅-C₈-cycloalkylphosphines L¹, L² and/or L³ is replaced by a secondary ammonium group (>NABD) and A, B and D are as defined above, wherein
a)
a1) at least part of the water,
a2) at least part of the at least one dispersant DP,
a3) at least part of the at least one ethylenically unsaturated monomer MON and
a4) optionally at least part of the organic solvent OS
a5) are placed in the form of an aqueous monomer macroemulsion having an average droplet diameter of ≧2 μm in a vessel, then
b) the monomer macroemulsion is converted with input of energy into a monomer miniemulsion having an average droplet diameter of ≦1500 nm and then
c) at the polymerization temperature,
c1) any remaining amount of the water,
c2) any remaining amount of the at least one dispersant DP,
c3) any remaining amount of the at least one monomer MON,
c4) any remaining amount of the organic solvent OS and
c5) the total amount of the metal-carbene complex C are added to the resulting monomer miniemulsion and the at least one monomer MON is polymerized to a monomer conversion of ≧80% by weight.

The invention likewise relates to aqueous polymer dispersions which are obtained by the process of the invention, the polymer powders which can be obtained from the aqueous polymer dispersions and also the use of the aqueous polymer dispersions or the polymer powders which can be obtained therefrom.

The term metathesis reaction refers quite generally to a chemical reaction between two compounds, in which a group is exchanged between the two reactants. If this reaction is an organic metathesis reaction, the substituents on a double bond are formally exchanged (see J. C. Mol, Industrial applications of olefin metathesis, Journal of Molecular Catalysis A: Chemical 213 (2004), pages 39 to 45). However, the ring-opening metathesis reaction of organic cycloolefin compounds (“ring opening metathesis polymerization”, ROMP for short) catalyzed by metal complexes by means of which polymeric polyolefins can be obtained is of particular importance. Catalytic metal complexes used are, in particular, metal-carbene complexes of the general structure Met=CR₂. The ring-opening polymerization then proceeds according to the general reaction scheme:

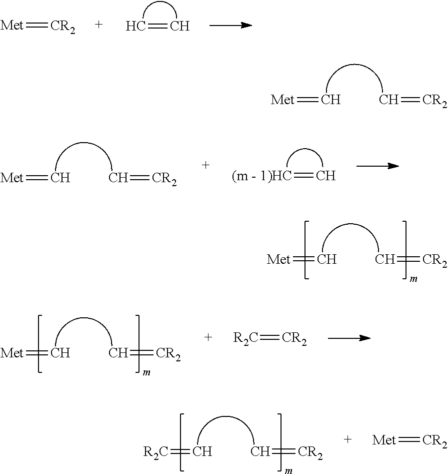

Owing to the high hydrolysis sensitivity of metal-carbene complexes, the metathesis reactions are frequently carried out in water-free organic solvents or the olefins themselves (see, for example, US-A 2008234451, EP-A 0824125, C. W. Bielawski, R. H. Grubbs in Prog. Polym. Sci. 32 (2007), pages 1 to 29, N. L. Wagner, F. J. Timmers, D. J. Arriola, G. Jueptner, B. G. Landes in Macromol. Rapid Commun. 2008, 29, page 1438). These processes have the disadvantage that the polymers obtained either comprise large amounts of solvent or of unreacted olefin which have to be separated off in complicated separation steps.

In carrying out metathesis reactions of olefins in an aqueous medium, the following prior art can be used as a basis.

Thus, DE-A 19859191 discloses a ring-opening metathesis reaction in an aqueous medium using metal-carbene complexes which have a low solubility in water. Here, the ring-opening metathesis reaction is carried out by placing water and dispersant in a polymerization vessel, dissolving metal-carbene complex in the cycloolefin, introducing the cycloolefin/metal complex solution into the aqueous dispersant solution, converting the cycloolefin/metal complex macroemulsion formed into a cycloolefin/metal complex miniemulsion and reacting this at room temperature to give an aqueous polyolefin dispersion. However, due to the rapid reaction of the catalyst with the cycloolefin used, only low polymerization conversions and often high coagulum values are obtained.

In Macromolecules 2001, 34, pages 382 to 388, Claverie et al. disclose ring-opening metathesis reactions using water-soluble metal-carbene complexes having ionic groups and also using water-insoluble metal-carbene complexes which have a hydrophobic structure. Here, the emulsion polymerization (diameter of the monomer droplets >2 μm) by means of the water-soluble metal-carbene complexes proceeds well only in the case of the highly strained norbornene while the less strained 1,5-cyclo-octadiene or cyclooctene gave only moderate polymer yields using the water-soluble metal-carbene complexes. To achieve a successful ring-opening metathesis reaction of 1,5-cyclooctadiene or cyclooctene, Claverie et al. used water-insoluble metal-carbene complexes having a hydrophobic structure which were firstly dissolved in organic solvents having a low solubility in water, this solution was subsequently converted in an aqueous dispersant solution into a metal-carbene complex/organic solvent miniemulsion (droplet diameter <1000 nm) and the appropriate cycloolefin was then added to this metal complex/solvent miniemulsion at polymerization temperature.

Ring-opening metathesis reactions of strained norbornene in aqueous miniemulsion using hydrophilic nonionic polyethylene oxide-functionalized metal-carbene complexes are disclosed by Y. Gnanou et al. in Journal of Polymer Science: Part A: Polymer Chemistry, 2006 (44), pages 2784 to 2793. Here, the ring-opening metathesis reaction is carried out by introducing norbornene dissolved in a hexadecane/dichloromethane solvent mixture into an aqueous dispersant solution, converting the resulting aqueous norbornene/solvent macroemulsion by means of ultrasound into a norbornene/solvent miniemulsion and introducing the respective hydrophilic nonionic polyethylene oxide-functionalized metal-carbene complexes into the norbornene/solvent miniemulsion at polymerization temperature.

EP-A 993465 indicates that ROMP reactions using the specific pentagonal or hexagonal metal-carbene complexes disclosed can in principle be carried out with or without solvent. If solvents are used, these solvents can be polar and protic in nature and comprise, for example, water. However, these ROMP reactions are preferably carried out without solvent, with the specific metal-carbene complexes being dissolved in an excess of cyclic olefin.

U.S. Pat. No. 6,759,537 discloses specific hexagonal metal-carbene complexes and their use in metathesis reactions, for example ROMP, ring-closing metathesis reactions or cross-metathesis reactions. These various metathesis reactions are said to be able in principle to be carried out with or without solvent. Suitable solvents are said to be all protic and aprotic organic solvents and also aqueous systems which are inert under the reaction conditions. However, aprotic solvents such as toluene or a mixture of benzene and dichloromethane are recommended as particularly preferred for the metal-carbene complexes disclosed.

It was an object of the present invention to provide a further metathesis process for producing aqueous polymer dispersions using metal-carbene complexes.

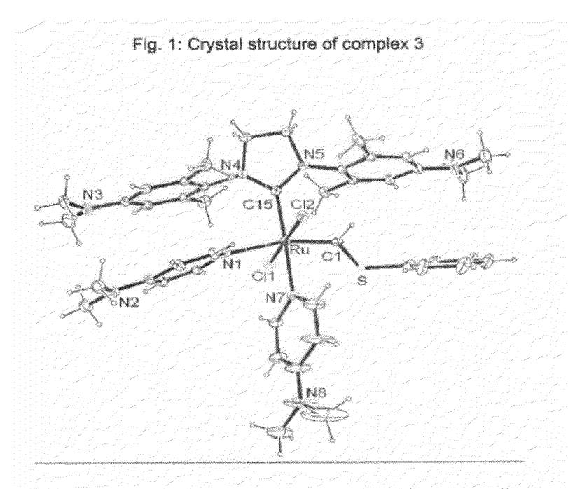

FIG. 1 is a structure of a crystal of the invention, as determined by X ray structure analysis.

We have accordingly found the process defined at the outset.

The metal-carbene complex C of the general formula (I)

MX¹X²L¹L²L³[=CR¹R²] (I)

is essential to the process.

Here, M is Os, Mo, W or Ru in the oxidation states +II, +III, +IV or +VI, but with the oxidation states +II, +III or +IV being preferred. M is particularly preferably Ru in the oxidation state +II.

X¹ and X² are each, independently of one another, a halide, pseudohalide, alkoxide, acetate, sulfate or phosphate. Suitable pseudohalides are, for example, cyanates, thiocyanates (rhodanides), selenocyanates, tellurocyanates, azides, isocyanates, cyanides. Suitable alkoxides are, for example, methoxide, ethoxide, n-propoxide, isopropoxide, n-butoxide or tert-butoxide. Preference is given to X¹ and X² each being, independently of one another, a halide such as fluoride, chloride, bromide or iodide, but with chloride being particularly preferred.

L¹, L² and L³ are each, independently of one another, 1,3-bis(C₁-C₅-alkyl)imidazolidin-2-ylidene, 1,3-bis(aryl)imidazolidin-2-ylidene, 1,3-bis(2,4,6-trimethylphenyl)imidazolidin-2-ylidene, 1,3-bis(2,4,6-tri-C₁-C₅-alkylphenyl)imidazolidin-2-ylidene, 1,3-bis(2,6-diisopropylphenyl)-4,5-imidazolin-2-ylidene, 1,3-bis(2,6-diisopropylphenyl)imidazolidin-2-ylidene, 1,3-bis(2,4-diisopropylphenyl)imidazolidin-2-ylidene, 1,3-bis(2,4-di-C₁-C₅-alkylphenyl)imidazolidin-2-ylidene, 1,3-bis(2,4,6-tri-C₅-C₈-cycloalkylphenyl)imidazolidin-2-ylidene, 1,3-bis(C₁-C₅-alkyl)imidazolin-2-ylidene, 1,3-bis(aryl)imidazolin-2-ylidene, 1,3-bis(2,4,6-trimethylphenyl)imidazolin-2-ylidene, 1,3-bis(2,4,6-tri-C₁-C₅-alkylphenyl)-imidazolin-2-ylidene, 1,3-bis(2,4-diisopropylphenyl)imidazolin-2-ylidene, 1,3-bis(2,4-di-C₁-C₅-alkylphenyl)imidazolin-2-ylidene, 1,3-bis(2,4,6-tri-C₅-C₈-cycloalkylphenyl)-imidazolin-2-ylidene, 3-bromopyridine, 3-chloropyridine, 3-fluoropyridine, 4-dimethyl-aminopyridine, 3-C₁-C₅-alkylpyridine, di-C₁-C₂₀-alkyl ether, di-C₃-C₂₀-cycloalkyl ether, 2-isopropoxyphenylmethylene, 2-isopropoxypyridine, triarylphosphine, tri-C₅-C₈-cycloalkylphosphine, tri-C₁-C₅-alkylphosphine or diaryl-C₁-C₅-alkylphosphine, with 1,3-bis(2,4,6-trimethylphenyl)imidazolidin-2-ylidene, 1,3-bis(2,4,6-tri-C₁-C₅-alkyl-phenyl)imidazolidin-2-ylidene, 4-dimethylaminopyridine, pyridine, triisopropylphosphine and/or tricyclohexylphosphine being preferred. However, particular preference is given to 1,3-bis(2,4,6-trimethylphenyl)imidazolidin-2-ylidene, tricyclohexylphosphine and/or 4-dimethylaminopyridine.

R¹ and R² are each, independently of one another, hydrogen, C₁-C₂₀-alkyl, C₂-C₂₀-alkenyl, C₄-C₈-cycloalkenyl, C₂-C₂₀-alkynyl, aryl, indenyl, 2-isopropoxyphenyl, 2-isopropoxy-5-(2,2,2-trifluoroacetamido)phenyl, C₁-C₂₀-alkoxyphenyl, C₁-C₂₀-alkoxy-amino, C₁-C₂₀-alkoxy, C₁-C₂₀-alkoxycarbonyl, C₂-C₂₀-alkenyloxy, C₂-C₂₀-alkynyloxy, aryloxy, C₁-C₂₀-alkylthio, arylthio, C₁-C₂₀-alkylsulfonyl, C₁-C₂₀-alkylsulfinyl or together form a radical [═CR³R⁴], where R³ and R⁴ are each, independently of one another, hydrogen, C₁-C₂₀-alkyl, C₂-C₂₀-alkenyl, C₂-C₂₀-alkynyl, aryl, indenyl, isopropoxyphenyl, C₁-C₂₀-alkoxyphenyl, C₁-C₂₀-alkoxyamino, C₁-C₂₀-alkoxy, C₁-C₂₀-alkoxycarbonyl, C₂-C₂₀-alkenyloxy, C₂-C₂₀-alkynyloxy, aryloxy, C₁-C₂₀-alkylthio, arylthio, C₁-C₂₀-alkylsulfonyl, C₁-C₂₀-alkylsulfinyl. Particular preference is given to R¹ and R² each being aryl, hydrogen, arylthio, indenyl, 2-isopropoxyphenyl or C₂-C₂₀-alkenyl, with aryl, in particular phenyl, arylthio, in particular thiophenyl, 2-isopropoxyphenyl and hydrogen being particularly preferred.

The alkyl radicals of the groups L^{1, L}², L³, R¹, R², R³ and R⁴ in general may optionally be substituted by 1, 2 or 3 groups selected from among C₁-C₅-alkyl, aryl, halogen, hydroxy, mercapto, C₁-C₅-alkoxy and C₁-C₅-alkoxycarbonyl, aminooxy, hydrazino, 4-sulfamoylanilino, sulfanilamido, carboxy, carboxyamido, acetamido, amino, nitro, cyano, sulfamoyl, amidino, hydroxycarbamoyl, carbamoyl, phosphonamino, hydroxy-phosphinoyl, phosphono, sulfino, sulfo, dithiocarboxy, thiocarboxy, furyl, pyridinyl, piperidinyl, furfuryl, pyrazolyl, isothiazolyl, pyrazinyl, pyrimidinyl, pyridazinyl, isoindolyl and indolyl, and the aryl radicals of the groups L¹, L², L³, R¹, R², R³ and R⁴ may optionally be substituted by 1, 2 or 3 groups selected from among C₁-C₅-alkyl, aryl, halogen, hydroxy, mercapto, C₁-C₅-alkoxy and C₁-C₅-alkoxycarbonyl, aminooxy, hydrazino, 4-sulfamoylanilino, sulfanilamido, carboxy, carboxyamido, acetamido, amino, nitro, cyano, sulfamoyl, amidino, hydroxycarbamoyl, carbamoyl, phosphonamino, hydroxyphosphinoyl, phosphono, sulfino, sulfo, dithiocarboxy, thiocarboxy, furyl, pyridinyl, piperidinyl, furfuryl, pyrazolyl, isothiazolyl, pyrazinyl, pyrimidinyl, pyridazinyl, isoindolyl and indolyl.

However, it is important for the purposes of the invention that at least one of the groups L¹, L², L³, R¹, R², R³ and R⁴ is substituted by at least one group selected from the group consisting of carboxylate (—CO₂Z), sulfonate (—SO₃Z), ammonium (—NABCD), phosphate (—PO₃Z), phosphonium (—PABCD), imidazolylium (-imidazolylAD), pyridylium (-pyridylAD), piperidylium (-piperidylABD), pyrylium (-pyryliumD), pyrazolylium (-pyrazolylAD), isothiazolylium (-isothiazolylAD), pyrazinylium (-pyrazinylAD), pyrimidinylium (-pyrimidinylAD) or pyridazinylium (-pyrazinylAD) which can be dissociated ionically in the aqueous reaction medium under polymerization conditions,

where
Z is a proton, an alkali metal cation such as, in particular, a sodium or potassium cation or ammonium,
A, B, C are each, independently of one another, hydrogen, C₁-C₅-alkyl, aryl and
D is an anion, for example a halide, in particular chloride or fluoride, hexaclhloro-phosphate (PCl₆—), hexafluorophosphate (PF₆—), hexafluoroarsenate (AsF₆—) or tetrachloroaluminate (AlCl₄—), with chloride or hexafluorophosphate (PF₆—) being preferred.

If L¹, L² and/or L³ is a tri-C₅-C₈-cycloalkylphosphine, it is also possible according to the invention for a methylene group in at least one of the C₅-C₈-cycloalkyl groups to be replaced by a secondary ammonium group (>NABD), where A, B and D are as defined above.

For the purposes of the present invention, a group which can be ionically dissociated in the aqueous reaction medium under polymerization conditions is any of the abovementioned groups which in the aqueous reaction medium under polymerization conditions eliminates either a group Z or a group D, where in the first case the ionized metal-carbene complex formed has at least one negative charge and in the second case it has at least one positive charge. Whether or not a group can be ionically dissociated under polymerization conditions can in the case of doubt be determined in a manner with which a person skilled in the art will be familiar, for example by means of conductivity measurements or solubility measurements in water.

For the purposes of the present text, a C₁-C₂₀-alkyl group is an aliphatic alkyl group having from 1 to 20 carbon atoms, in particular methyl, ethyl, n-propyl, n-butyl, n-pentyl, n-hexyl, n-heptyl, n-octyl, n-nonyl, n-decyl, n-undecyl, n-dodecyl, n-tridecyl, n-tetra-decyl, n-pentadecyl, n-hexadecyl, n-heptadecyl, n-octadecyl, n-nonadecyl, n-eicosyl and isomeric compounds thereof, for example isopropyl, tert-butyl; an aryl group is essentially a phenyl, anthranyl or phenanthryl group, but preferably a phenyl group; and a C₃-C₂₀-cycloalkyl group is a cycloaliphatic group having from 3 to 20 carbon atoms, for example cyclopropyl, cyclobutyl, cyclopentyl, cyclohexyl, cycloheptyl or cyclooctyl.

Metal-carbene complexes C of the general formula (I) can, for example, be prepared by functionalization reactions which are known to those skilled in the art of the corresponding compounds disclosed, for example, in EP-A 993465, in particular the compounds of the general formula (I′b) and also example 4 or in U.S. Pat. No. 6,759,537, in particular the metal-carbene complexes 5 to 29 (columns 15 to 19) and the examples in column 32, lines 49 and 62, column 33, lines 29 and 42, column 34, lines 1, 44 and 57, column 35, lines 22 and 35, column 36, lines 28, 29, 41, 42, 54 and 55, column 37, lines 14, 15, 27, 28, 41, 42, 54 and 55, column 38, lines 19, 20, 33 and 34, column 39, lines 3, 4, 17, 18, 60 and 61 and also column 40, line 24. These are expressly incorporated by reference into the present text. Metal-carbene complexes C can likewise be prepared according to the abovementioned synthetic principles for preparing hexagonal metal-carbene complexes using specific precursors bearing appropriate functional groups.

In the process of the invention, it is advantageous to use a metal-carbene complex C which is a dimethylammonium reaction product prepared from a metal-carbene complex selected from the group consisting of dichloro-1,3-bis(2,6-dimethyl-4-dimethylaminophenyl)imidazolidin-2-ylidenebis(4-dimethylaminopyridine)benzylideneruthenium(II), dichloro-1,3-bis(2,6-dimethyl-4-dimethylaminophenyl)imidazolin-2-ylidenebis(4-dimethylaminopyridine)benzylideneruthenium(II), dichloro-1,3-bis(2,6-dimethyl-4-dimethylaminophenyl)imidazolidin-2-ylidenebis(4-dimethylaminopyridine)-phenylthiomethyleneruthenium(II) and/or dichloro-1,3-bis(2,6-dimethyl-4-dimethyl-aminophenyl)imidazolin-2-ylidenebis(4-dimethylaminopyridine)phenylthiomethyleneruthenium(II).

Dichloro-1,3-bis(2,6-dimethyl-4-dimethylanninophenyl)innidazolidin-2-ylidenebis(4-dimethylaminopyridine)phenylthiomethyleneruthenium(II) and/or dichloro-1,3-bis(2,6-dimethyl-4-dimethylaminophenyl)imidazolin-2-ylidenebis(4-dimethylaminopyridine)-phenylthiomethyleneruthenium(II) are particularly advantageously used for preparing the metal-carbene complex C.

Here, the dimethylammonium reaction products are prepared by reacting dichloro-1,3-bis(2,6-dimethyl-4-dimethylaminophenypimidazolidin-2-ylidenebis(4-dimethylamino-pyridine)benzylideneruthenium(II) (complex 1), dichloro-1,3-bis(2,6-dimethyl-4-dimethylaminophenyl)imidazolin-2-ylidenebis(4-dimethylaminopyridine)benzylideneruthenium(II) (complex 2), dichloro-1,3-bis(2,6-dimethyl-4-dimethylaminophenyl)-imidazolidin-2-ylidenebis(4-dimethylaminopyridine)phenylthiomethyleneruthenium(II) (complex 3) and/or dichloro-1,3-bis(2,6-dimethyl-4-dimethylaminophenyl)imidazoline-2-ylidenebis(4-dimethylaminopyridine)phenylthiomethyleneruthenium(II) (complex 4) with a Brönsted acid compound in a type and amount with which those skilled in the art would be familiar under such reaction conditions that at least one of the dimethylamino groups present in the complexes 1 to 4 is converted into the corresponding dimethylammonium group.

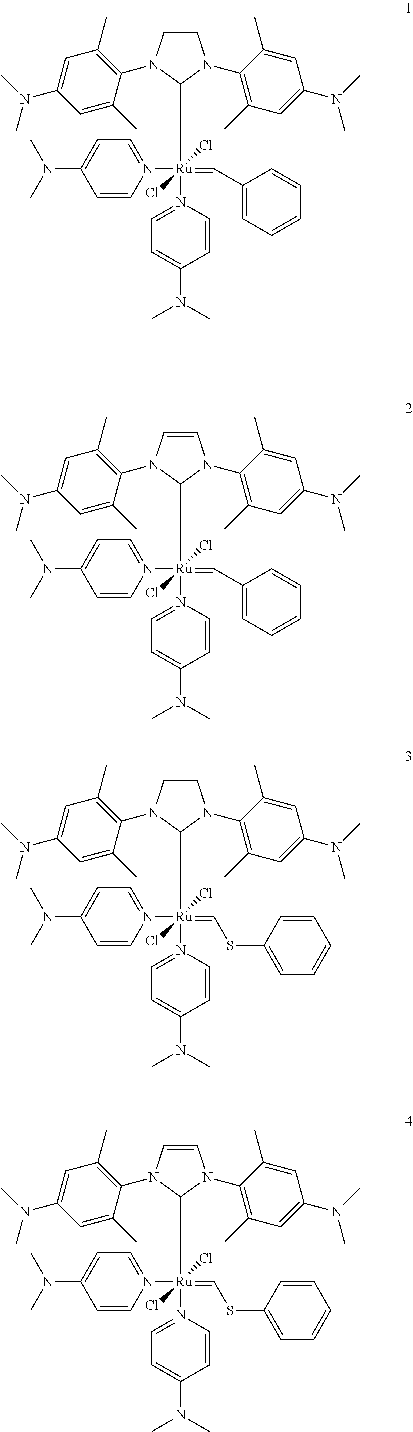

Brönsted acid compounds used are organic, inorganic protic acids and also alkylating reagents. Suitable protic acids are, in particular, those which have a pKₐ of <5, for example organic carboxylic acids or sulfonic acids or inorganic acids based on elements of Main Groups 5, 6 and 7 of the Periodic Table, for example phosphoric acid, sulfuric acid and/or hydrochloric acid. The Brönsted acid compounds advantageously have no oxidizing properties. The Brönsted acid compound is used in such a type and amount that at least one, preferably at least two and particularly preferably all, of the dimethylamino groups present in the complexes 1 to 4 are present in the form of the corresponding dimethylammonium groups.

Of course, it is also possible, according to the invention, to use a mixture of different metal-carbene complexes M which do not interfere with one another.

It is essential to the invention that
a) in a vessel,
a1) at least part of the water,
a2) at least part of the at least one dispersant DP,
a3) at least part of the at least one ethylenically unsaturated monomer MON and
a4) optionally at least part of the organic solvent OS
a5) are placed in the form of an aqueous monomer macroemulsion having an average droplet diameter of ≧2 μm in a vessel, then
b) the monomer macroemulsion is converted with input of energy into a monomer miniemulsion having an average droplet diameter of ≦1500 nm and then
c) at the polymerization temperature,
c1) any remaining amount of the water,
c2) any remaining amount of the at least one dispersant DP,
c3) any remaining amount of the at least one monomer MON,
c4) any remaining amount of the organic solvent OS and
c5) the total amount of the metal-carbene complex C are added to the resulting monomer miniemulsion and the at least one monomer MON is polymerized to a monomer conversion of ≧80% by weight.

For the purposes of the invention, plain water, but in particular deionized water, is used. Here, at least part of the water is placed in a vessel in process step al) and any remaining amount of the water is added in process step c1). It is advantageous to place ≧50% by weight, particularly advantageously ≧70% by weight and very particularly advantageously ≧90% by weight, of the total amount of water in the vessel in process step a1). Here, the total amount of water is from ≧10 to ≦9900 parts by weight, advantageously from ≧20 to ≦1900 parts by weight and very particularly advantageously from ≧30 to ≦900 parts by weight, per 100 parts by weight of monomers MON.

In the production according to the invention of aqueous polymer dispersions, concomitant use is generally made of dispersants DP which keep both the monomer droplets or monomer/solvent droplets of the corresponding macroemulsions and miniemulsions and also the polymer particles formed dispersed in the aqueous polymerization medium and thus ensure the stability of the aqueous polymer dispersions produced. Possible dispersants DP are both the protective colloids customarily used for carrying out free-radical aqueous emulsion polymerizations and also emulsifiers.

A comprehensive description of suitable protective colloids may be found in Houben-Weyl, Methoden der organischen Chemie, volume XIV/1, Makromolekulare Stoffe, Georg-Thieme-Verlag, Stuttgart, 1961, pages 411 to 420.

Suitable uncharged protective colloids are, for example, polyvinyl alcohols, polyalkylene glycols, polyvinylpyrrolidones, cellulose derivatives, starch derivatives and gelatin derivatives.

Possible anionic protective colloids, i.e. protective colloids whose component having a dispersing action has at least one negative electric charge, are, for example, polyacrylic acids and polymethacrylic acids and their alkali metal salts, copolymers comprising acrylic acid, methacrylic acid, itaconic acid, 2-acrylamido-2-methyl-propanesulfonic acid, 4-styrenesulfonic acid and/or maleic anhydride and their alkali metal salts and also alkali metal salts of sulfonic acids of high molecular weight compounds, for example polystyrene.

Suitable cationic protective colloids, i.e. protective colloids whose component having a dispersing action has at least one positive electric charge, are, for example, the N-protonated and/or -alkylated derivatives of homopolymers and copolymers of N-vinylpyrrolidone, N-vinylcaprolactam, N-vinylformamide, N-vinylacetamide, N-vinylcarbazole, 1-vinylimidazole, 2-vinylimidazole, 2-vinylpyridine, 4-vinylpyridine, acrylamide, methacrylamide, amine-group-bearing acrylates, methacrylates, acrylamides and/or methacrylamides.

Of course, it is also possible to use mixtures of emulsifiers and/or protective colloids. Emulsifiers whose relative molecular weights are, in contrast to the protective colloids, usually below 1500 g/mol are frequently exclusively used as dispersants. Of course, when mixtures of surface-active substances are used, the individual components have to be compatible with one another, which in the case of doubt can be checked by means of a few preliminary tests. An overview of suitable emulsifiers may be found in Houben-Weyl, Methoden der organischen Chemie, volume XIV/1, Makromolekulare Stoffe, Georg-Thieme-Verlag, Stuttgart, 1961, pages 192 to 208.

Customary nonionic emulsifiers are, for example, ethoxylated monoalkylphenols, dialkylphenols and trialkylphenols (EO units: 2-50, alkyl radical: C₄-C₁₂) and ethoxylated fatty alcohols (EO units: 2-80; alkyl radical: C₈-C₃₆). Examples are the Emulgin® B grades (cetyl/stearyl alcohol ethoxylates), Dehydrol® LS grades (fatty alcohol ethoxylates, EO units: 1-10) from COGNIS GmbH, and the Lutensol® A grades (C₁₂C₁₄-fatty alcohol ethoxylates, EO units: 3-8), Lutensol® AO grades (C₁₃C₁₅-oxo alcohol ethoxylates, EO units: 3-30), Lutensol® AT grades (C₁₆C₁₈-fatty alcohol ethoxylates, EO units: 11-80), Lutensol® ON grades (C₁₀-oxo alcohol ethoxylates, EO units: 3-11) and Lutensol® TO grades (C₁₃-oxo alcohol ethoxylates, EO units: 3-20) from BASF SE. As an alternative, it is possible to use low molecular weight, random and water-soluble ethylene oxide and propylene oxide copolymers and derivatives thereof, low molecular weight, water-soluble ethylene oxide and propylene oxide block copolymers (for example Pluronic® PE having a molecular weight of from 1000 to 4000 g/mol and Pluronic® RPE from BASF SE having a molecular weight of from 2000 to 4000 g/mol) and derivatives thereof.

Customary anionic emulsifiers are, for example, alkali metal and ammonium salts of alkylsulfates (alkyl radical: C₈-C₁₂), of sulfuric acid monoesters of ethoxylated alkanols (EO units: 4-30, alkyl radical: C₁₂-C₁₈) and ethoxylated alkylphenols (EO units: 3-50, alkyl radical: C₄-C₁₂), of alkylsulfonic acids (alkyl radical: C₁₂-C₁₈) and of alkylarylsulfonic acids (alkyl radical: C₉-C₁₈).

As further anionic emulsifiers, compounds of the general formula (II)

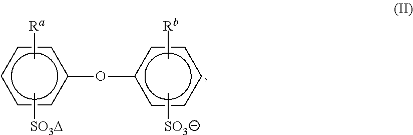

where R^{a} and R^{b} are each an H atom or C₄-C₂₄-alkyl and are not both H atoms at the same time, and Δ and ⊖ can be alkali metal ions and/or ammonium ions, have also been found to be useful. In the general formula (II), R^{a} and R^{b} are preferably linear or branched alkyl radicals having from 6 to 18 carbon atoms, in particular 6, 12 or 16 carbon atoms or —H, where R^{a} and R^{b} are not both H atoms at the same time, Δ and ⊖ are preferably sodium, potassium or ammonium, with sodium being particularly preferred. Compounds (II) in which Δ and ⊖ are each sodium, R^{a} is a branched alkyl radical having 12 carbon atoms and R^{b} is an H atom or R^{a} are particularly advantageous. Use is frequently made of industrial mixtures which have a proportion of from 50 to 90% by weight of the monoalkylated product, for example Dowfax® 2A1 (brand of Dow Chemical Corp.). The compounds (II) are generally known, e.g. from U.S. Pat. No. 4,269,749, and commercially available.

Suitable cation-active emulsifiers are primary, secondary, tertiary or quaternary ammonium salts which generally have a C₆-C₁₈-alkyl, C₆-C₁₈-aralkyl or heterocyclic radical, alkanolammonium salts, pyridinium salts, imidazolinium salts, oxazolinium salts, morpholinium salts, thiazolinium salts and salts of amine oxides, quinolinium salts, isoquinolinium salts, tropylium salts, sulfonium salts and phosphonium salts. Examples which may be mentioned are dodecylammonium acetate or the corresponding hydrochloride, the chlorides or acetates of the various 2-(N,N,N-trimethylammonio)ethyl paraffinic acid esters, N-cetylpyridinium chloride, N-lauryl-pyridinium sulfate and N-cetyl-N,N,N-trimethylammonium bromide, N-dodecyl-N,N,N-trimethylammonium bromide, N-octyl-N,N,N-trimethlyammonium bromide, N,N-di-stearyl-N,N-dimethylammonium chloride and also the Gemini surfactant N,N′-(lauryl-dimethyl)ethylenediamine dibromide. Numerous further examples may be found in H. Stache, Tensid-Taschenbuch, Carl-Hanser-Verlag, Munich, Vienna, 1981 and in McCutcheon's, Emulsifiers & Detergents, MC Publishing Company, Glen Rock, 1989.

According to the invention, at least part of the dispersant DP is placed in the vessel in process step a2) and any remaining amount of the dispersant DP is added in process step c2). It is advantageous to place ≧50% by weight, particularly advantageously ≧70% by weight and very particularly advantageously ≧90% by weight, of the total amount of dispersant in the vessel in process step a2). It is especially advantageous to place the total amount of the dispersant DP in the vessel in process step a2).

The total amount of dispersant is, according to the invention, from ≧0.1 to ≦10% by weight, advantageously from ≧0.3 to ≦8% by weight and particularly advantageously from ≧0.5 to ≦6% by weight, in each case based on the total amount of the monomers MON. Preference is given to using emulsifiers, in particular nonionic and/or cationic emulsifiers. It is particularly advantageous to use nonionic emulsifiers.

Possible ethylenically unsaturated monomers MON are essentially aliphatic linear or branched C₃-C₃₀-alkenes and monocyclic or polycyclic olefins which have one or more ethylenically unsaturated double bonds and may optionally also bear functional groups. The monomers MON advantageously have no further elements in addition to carbon and hydrogen. Monomers MON include, for example, the linear alkenes propene, n-1-butene, n-2-butene, 2-methylpropene, 2-methyl-1-butene, 3-methyl-1-butene, 3,3-dimethyl-2-isopropyl-1-butene, 2-methyl-2-butene, 3-methyl-2-butene, 1-pentene, 2-methyl-1-pentene, 3-methyl-1-pentene, 4-methyl-1-pentene, 2-pentene, 2-methyl-2-pentene, 3-methyl-2-pentene, 4-methyl-2-pentene, 2-ethyl-1-pentene, 3-ethyl-1-pentene, 4-ethyl-1-pentene, 2-ethyl-2-pentene, 3-ethyl-2-pentene, 4-ethyl-2-pentene, 2,4,4-trimethyl-1-pentene, 2,4,4-trimethyl-2-pentene, 3-ethyl-2-methyl-1-pentene, 3,4,4-trimethyl-2-pentene, 2-methyl-3-ethyl-2-pentene, 1-hexene, 2-methyl-1-hexene, 3-methyl-1-hexene, 4-methyl-1-hexene, 5-methyl-1-hexene, 2-hexene, 2-methyl-2-hexene, 3-methyl-2-hexene, 4-methyl-2-hexene, 5-methyl-2-hexene, 3-hexene, 2-methyl-3-hexene, 3-methyl-3-hexene, 4-methyl-3-hexene, 5-methyl-3-hexene, 2,2-dimethyl-3-hexene, 2,3-dimethyl-2-hexene, 2,5-dimethyl-3-hexene, 2,5-dimethyl-2-hexene, 3,4-dimethyl-1-hexene, 3,4-dimethyl-3-hexene, 5,5-dimethyl-2-hexene, 2,4-dimethyl-1-hexene, 1-heptene, 2-methyl-1-heptene, 3-methyl-1-heptene, 4-methyl-1-heptene, 5-methyl-1-heptene, 6-methyl-1-heptene, 2-heptene, 2-methyl-2-heptene, 3-methyl-2-heptene, 4-methyl-2-heptene, 5-methyl-2-heptene, 6-methyl-2-heptene, 3-heptene, 2-methyl-3-heptene, 3-methyl-3-heptene, 4-methyl-3-heptene, 5-methyl-3-heptene, 6-methyl-3-heptene, 6,6-dimethyl-1-heptene, 3,3-dimethyl-1-heptene, 3,6-dimethyl-1-heptene, 2,6-dimethyl-2-heptene, 2,3-dimethyl-2-heptene, 3,5-dimethyl-2-heptene, 4,5-dimethyl-2-heptene, 4,6-dimethyl-2-heptene, 4-ethyl-3-heptene, 2,6-dimethyl-3-heptene, 4,6-dimethyl-3-heptene, 2,5-dimethyl-4-heptene, 1-octene, 2-methyl-1-octene, 3-methyl-1-octene, 4-methyl-1-octene, 5-methyl-1-octene, 6-methyl-1-octene, 7-methyl-1-octene, 2-octene, 2-methyl-2-octene, 3-methyl-2-octene, 4-methyl-2-octene, 5-methyl-2-octene, 6-methyl-2-octene, 7-methyl-2-octene, 3-octene, 2-methyl-3-octene, 3-methyl-3-octene, 4-methyl-3-octene, 5-methyl-3-octene, 6-methyl-3-octene, 7-methyl-3-octene, 4-octene, 2-methyl-4-octene, 3-methyl-4-octene, 4-methyl-4-octene, 5-methyl-4-octene, 6-methyl-4-octene, 7-methyl-4-octene, 7,7-dimethyl-1-octene, 3,3-dimethyl-1-octene, 4,7-dimethyl-1-octene, 2,7-dimethyl-2-octene, 2,3-dimethyl-2-octene, 3,6-dimethyl-2-octene, 4,5-dimethyl-2-octene, 4,6-dimethyl-2-octene, 4,7-dimethyl-2-octene, 4-ethyl-3-octene, 2,7-dimethyl-3-octene, 4,7-dimethyl-3-octene, 2,5-dimethyl-4-octene, 1-nonene, 2-methyl-1-nonene, 3-methyl-1-nonene, 4-methyl-1-nonene, 5-methyl-1-nonene, 6-methyl-1-nonene, 7-methyl-1-nonene, 8-methyl-1-nonene, 2-nonene, 2-methyl-2-nonene, 3-methyl-2-nonene, 4-methyl-2-nonene, 5-methyl-2-nonene, 6-methyl-2-nonene, 7-methyl-2-nonene, 8-methyl-2-nonene, 3-nonene, 2-methyl-3-nonene, 3-methyl-3-nonene, 4-methyl-3-nonene, 5-methyl-3-nonene, 6-methyl-3-nonene, 7-methyl-3-nonene, 8-methyl-3-nonene, 4-nonene, 2-methyl-4-nonene, 3-methyl-4-nonene, 4-methyl-4-nonene, 5-methyl-4-nonene, 6-methyl-4-nonene, 7-methyl-4-nonene, 8-methyl-4-nonene, 4,8-dimethyl-1-nonene, 4,8-dimethyl-4-nonene, 2,8-dimethyl-4-nonene, 1-decene, 2-methyl-1-decene, 3-methyl-1-decene, 4-methyl-1-decene, 5-methyl-1-decene, 6-methyl-1-decene, 7-methyl-1-decene, 8-methyl-1-decene, 9-methyl-1-decene, 2-decene, 2-methyl-2-decene, 3-methyl-2-decene, 4-methyl-2-decene, 5-methyl-2-decene, 6-methyl-2-decene, 7-methyl-2-decene, 8-methyl-2-decene, 9-methyl-2-decene, 3-decene, 2-methyl-3-decene, 3-methyl-3-decene, 4-methyl-3-decene, 5-methyl-3-decene, 6-methyl-3-decene, 7-methyl-3-decene, 8-methyl-3-decene, 9-methyl-3-decene, 4-decene, 2-methyl-4-decene, 3-methyl-4-decene, 4-methyl-4-decene, 5-methyl-4-decene, 6-methyl-4-decene, 7-methyl-4-decene, 8-methyl-4-decene, 9-methyl-4-decene, 5-decene, 2-methyl-5-decene, 3-methyl-5-decene, 4-methyl-5-decene, 5-methyl-5-decene, 6-methyl-5-decene, 7-methyl-5-decene, 8-methyl-5-decene, 9-methyl-5-decene, 2,4-dimethyl-1-decene, 2,4-dimethyl-2-decene, 4,8-dimethyl-1-decene, 1-undecene, 2-methyl-1-undecene, 3-methyl-1-undecene, 4-methyl-1-undecene, 5-methyl-1-undecene, 6-methyl-1-undecene, 7-methyl-1-undecene, 8-methyl-1-undecene, 9-methyl-1-undecene, 10-methyl-1-undecene, 2-undecene, 2-methyl-2-undecene, 3-methyl-2-undecene, 4-methyl-2-undecene, 5-methyl-2-undecene, 6-methyl-2-undecene, 7-methyl-2-undecene, 8-methyl-2-undecene, 9-methyl-2-undecene, 10-methyl-2-undecene, 3-undecene, 2-methyl-3-undecene, 3-methyl-3-undecene, 4-methyl-3-undecene, 5-methyl-3-undecene, 6-methyl-3-undecene, 7-methyl-3-undecene, 8-methyl-3-undecene, 9-methyl-3-undecene, 10-methyl-3-undecene, 4-undecene, 2-methyl-4-undecene, 3-methyl-4-undecene, 4-methyl-4-undecene, 5-methyl-4-undecene, 6-methyl-4-undecene, 7-methyl-4-undecene, 8-methyl-4-undecene, 9-methyl-4-undecene, 10-methyl-4-undecene, 5-undecene, 2-methyl-5-undecene, 3-methyl-5-undecene, 4-methyl-5-undecene, 5-methyl-5-undecene, 6-methyl-5-undecene, 7-methyl-5-undecene, 8-methyl-5-undecene-5, 9-methyl-5-undecene, 10-methyl-5-undecene, 1-dodecene, 2-dodecene, 3-dodecene, 4-dodecene, 5-dodecene, 6-dodecene, 4,8-dimethyl-1-decene, 4-ethyl-1-decene, 6-ethyl-1-decene, 8-ethyl-1-decene, 2,5,8-trimethyl-1-nonene, 1-tridecene, 2-tridecene, 3-tridecene, 4-tridecene, 5-tridecene, 6-tridecene, 2-methyl-1-dodecene, 11-methyl-1-dodecene, 2,5-dimethyl-2-undecene, 6,10-dimethyl-1-undecene, 1-tetradecene, 2-tetradecene, 3-tetradecene, 4-tetradecene, 5-tetra-decene, 6-tetradecene, 7-tetradecene, 2-methyl-1-tridecene, 2-ethyl-1-dodecene, 2,6,10-trimethyl-1-undecene, 2,6-dimethyl-2-dodecene, 11-methyl-1-tridecene, 9-methyl-1-tridecene, 7-methyl-1-tridecene, 8-ethyl-1-dodecene, 6-ethyl-1-dodecene, 4-ethyl-1-dodecene, 6-butyl-1-decene, 1-pentadecene, 2-pentadecene, 3-pentadecene, 4-pentadecene, 5-pentadecene, 6-pentadecene, 7-pentadecene, 2-methyl-1-tetra-decene, 3,7,11-trimethyl-1-dodecene, 2,6,10-trimethyl-1-dodecene, 1-hexadecene, 2-hexadecene, 3-hexadecene, 4-hexadecene, 5-hexadecene, 6-hexadecene, 7-hexa-decene, 8-hexadecene, 2-methyl-1-pentadecene, 3,7,11-trimethyl-1-tridecene, 4,8,12-trimethyl-1-tridecene, 11-methyl-1-pentadecene, 13-methyl-1-pentadecene, 7-methyl-1-pentadecene, 9-methyl-1-pentadecene, 12-ethyl-1-tetradecene, 8-ethyl-1-tetradecene, 4-ethyl-1-tetradecene, 8-butyl-1-dodecene, 6-butyl-1-dodecene, 1-heptadecene, 2-heptadecene, 3-heptadecene, 4-heptadecene, 5-heptadecene, 6-heptadecene, 7-heptadecene, 8-heptadecene, 2-methyl-1-hexadecene, 4,8,12-trimethyl-1-tetra-decene, 1-octadecene, 2-octadecene, 3-octadecene, 4-octadecene, 5-octadecene, 6-octadecene, 7-octadecene, 8-octadecene, 9-octadecene, 2-methyl-1-heptadecene, 13-methyl-1-heptadecene, 10-butyl-1-tetradecene, 6-butyl-1-tetradecene, 8-butyl-1-tetradecene, 10-ethyl-1-hexadecene, 1-nonadecene, 2-nonadecene, 1-methyl-1-octa-decene, 7,11,15-trimethyl-1-hexadecene, 1-eicosene, 2-eicosene, 2,6,10,14-tetra-methyl-2-hexadecene, 3,7,11,15-tetramethyl-2-hexadecene, 2,7,11,15-tetramethyl-1-hedexacene, 1-docosene, 2-docosene, 7-docosene, 4,9,13,17-tetramethyl-1-octa-decene, 1-tetracosene, 2-tetracosene, 9-tetracosene, 1-hexacosene, 2-hexacosene, 9-hexacosene, 1-triacontene, 1-dotriacontene or 1-tritriacontene and also the mono-cyclic or polycyclic aliphatic olefins cyclopentene, 1,3-cyclopentadiene, dicyclopentadiene(3a,4,7,7a-tetrahydro-1H-4,7-methanoindene), 2-methyl-1-cyclopentene, 3-methyl-1-cyclopentene, 4-methyl-1-cyclopentene, 3-butyl-1-cyclopentene, vinyl-cyclopentane, cyclohexene, 2-methyl-1-cyclohexene, 3-methyl-1-cyclohexene, 4-methyl-1-cyclohexene, 1,4-dimethyl-1-cyclohexene, 3,3,5-trimethyl-1-cyclohexene, 4-cyclopentyl-1-cyclohexene, vinylcyclohexane, cycloheptene, 1,2-dimethyl-1-cyclo-heptene, cis-cyclooctene, trans-cyclooctene, 2-methyl-1-cyclooctene, 3-methyl-1-cyclooctene, 4-methyl-1-cyclooctene, 5-methyl-1-cyclooctene, 1,5-cyclooctadiene, cyclononene, cyclodecene, cycloundecene, cyclododecene, 2-bicyclo[2.2.1]heptene, 5-ethyl-2-bicyclo[2.2.1]heptene, 2-methyl-2-bicyclo[2.2.2]octene, 2-bicyclo[3.3.1]-nonene or 6-bicyclo[3.2.2]nonene. Of course, it is also possible to use mixtures of the abovementioned monomers MON according to the invention. It is advantageous, according to the invention, to use linear alkenes or cyclic olefins which under polymerization conditions are liquid and have a low solubility in water and are thus present as a separate phase in the aqueous polymerization medium under polymerization conditions. According to the invention, preference is given to using monocyclic or polycyclic aliphatic olefins and particularly preference to cis-cyclooctene, trans-cyclooctene and/or dicyclopentadiene. The total amount of monomers MON is from ≧1 to ≦90% by weight, advantageously from ≧5 to ≦80% by weight and particularly advantageously from ≧10 to ≦70% by weight, in each case based on the total amount of the resulting aqueous polymer dispersion.

In process step a3), at least part of the at least one ethylenically unsaturated monomer MON is placed in a vessel and any remaining amount of the at least one monomer MON is added in process step c3). It is advantageous to place ≧50% by weight, particularly advantageously ≧70% by weight and very particularly advantageously ≧90% by weight, of the total amount of the monomers MON in the vessel in process step a3). It is particularly advantageous to place the total amount of the monomers MON in the vessel in process step a3).

In the process of the invention, organic solvents OS which even under polymerization conditions (at a given pressure and a given temperature) have a low solubility in water, i.e. a solubility of ≦10 g, advantageously ≦1 g and particularly advantageously ≦0.2 g, per liter of deionized water are optionally used. The organic solvents OS can serve, firstly, to dissolve the monomers MON and thus reduce their concentration in the macroemulsion or miniemulsion droplets and, secondly, to ensure the stability of the thermodynamically unstable miniemulsion droplets (by preventing Ostwald ripening).

Suitable organic solvents OS are liquid aliphatic and aromatic hydrocarbons having from 5 to 30 carbon atoms, for example n-pentane and isomers, cyclopentane, n-hexane and isomers, cyclohexane, n-heptane and isomers, n-octane and isomers, n-nonane and isomers, n-decane and isomers, n-dodecane and isomers, n-tetra-decane and isomers, n-hexadecane and isomers, n-octadecane and isomers, benzene, toluene, ethylbenzene, cumene, o-, m- or p-xylene, and also hydrocarbon mixtures in general having a boiling range of from 30 to 250° C. It is likewise possible to use esters such as fatty acid esters having from 10 to 28 carbon atoms in the acid part and from 1 to 10 carbon atoms in the alcohol part or esters of carboxylic acids and fatty alcohols having from 1 to 10 carbon atoms in the carboxylic acid part and from 10 to 28 carbon atoms in the alcohol part. It is of course also possible to use mixtures of the abovementioned solvents.

The organic solvent OS is advantageously selected from the group consisting of n-hexane, n-octane, n-decane, n-tetradecane, n-hexadecane and the isomeric compounds thereof, benzene, toluene and/or ethylbenzene.

As an alternative, it is also possible to use, in a similar manner to organic solvents OS, oligomers or polymers which are not soluble in water and even under polymerization conditions (at a given pressure and a given temperature) have a low solubility in water, i.e. a solubility of ≦10 g, advantageously ≦1 g and particularly advantageously ≦0.2 g, per liter of deionized water in order to prevent Ostwald ripening. Suitable substances of this type are, for example, polystyrene, polystearyl acrylate, polybutadiene, polyisobutylene, polynorbornene, polyoctenamer, polydicyclopentadiene or styrene-butadiene rubber.

In process step a4), at least part of the organic solvent OS is optionally placed in the vessel and any remaining amount of the organic solvent OS is added in process step c4). It is advantageous to place ≧50% by weight, particularly advantageously ≧70% by weight and very particularly advantageously ≧90% by weight, of the total amount of organic solvent OS in the vessel in process step a4). It is particularly advantageous to place the total amount of organic solvent OS in the vessel in process step a4).

The total amount of organic solvent OS is from ≧0.1 to ≦15% by weight, advantageously from ≧0.5 to ≦10% by weight and very particularly advantageously from ≧1 to ≦8% by weight, in each case based on the total amount of monomers MON.

A monomer macroemulsion having an average droplet diameter of ≧2 μm, frequently ≧5 μm and often ≧10 μm is formed by simple mixing or stirring of the components water, dispersant DP, monomers MON and optionally solvent OS initially placed in a vessel in process steps a1) to a4). The average droplet diameter can be determined in a simple way with which a person skilled in the art will be familiar, for example by the method of dynamic light scattering (DLS).

The monomer macroemulsion is converted into a monomer miniemulsion having an average droplet diameter of ≦1500 nm by input of energy in process step b) according to the invention.

The general production of aqueous miniemulsions from aqueous macroemulsions or mixtures with input of energy is adequately known to those skilled in the art (see, for example, M. S. El-Aasser et al., Journal of Applied Polymer Science, Vol. 43, pages 1059 to 1066 [1991] or WO-A 2006/053712).

For this purpose, it is possible to employ, for example, high-pressure homogenizers. In these machines, the fine dispersion of the components is achieved by means of a high local energy input. Two variants have been found to be particularly useful for this purpose.

In the first variant, the aqueous macroemulsion is compressed to above 1000 bar by means of a piston pump and subsequently depressurized through a narrow slit. The effect here is based on an interaction of high shear and pressure gradients and cavitation in the slit. An example of a high-pressure homogenizer which functions according to this principle is the Niro-Soavi high-pressure homogenizer model NS1001L Panda.

In the second variant, the compressed aqueous macroemulsion is depressurized through two opposed nozzles into a mixing chamber. The fine dispersing action is in this case dependent primarily on the hydrodynamic conditions in the mixing chamber. An example of this type of homogenizer is the Microfluidizer model M 120 E from Microfluidics Corp. In this high-pressure homogenizer, the aqueous macroemulsion is compressed by means of a pneumatically operated piston pump to pressures of up to 1200 atm and depressurized via an “interaction chamber”. In the interaction chamber, the jet of emulsion is divided in a microchannel system into two jets which are directed at one another at an angle of 180°. A further example of a homogenizer which operates according to this homogenizing principle is the Nanojet model Expo from Nanojet Engineering GmbH. However, two homogenizing valves which can be mechanically adjusted are installed in the Nanojet instead of a fixed channel system.

Apart from the principles explained above, the homogenization can also, for example, be carried out by use of ultrasound (e.g. Branson Sonifier II 450). The fine dispersion is in this case based on cavitation mechanisms. The apparatuses described in GB-A 22 50 930 and U.S. Pat. No. 5,108,654 are also suitable in principle for homogenization by means of ultrasound. The quality of the aqueous miniemulsion produced in the sonic field depends not only on the sonic power introduced but also on other factors such as the intensity distribution of the ultrasound in the mixing chamber, the residence time, the temperature and the physical properties of the materials to be emulsified, for example the viscosity, the surface tension and the vapor pressure. The resulting droplet size depends, inter alia, on the concentration of the dispersant and also on the energy introduced during homogenization and can therefore be set in a targeted manner by, for example, appropriate alteration of the homogenization pressure or of the corresponding ultrasonic energy.

To produce the aqueous miniemulsion which is advantageously used according to the invention from conventional macroemulsions by means of ultrasound, the apparatus described in the early German patent application DE 197 56 874 has been found to be particularly useful. This is an apparatus which has a reaction space or a flow-through reaction channel and at least one means of transmitting ultrasonic waves into the reaction space or the flow-through reaction channel, with the means of transmitting ultrasonic waves being configured so that the entire reaction space or a section of the flow-through reaction channel can be irradiated uniformly with ultrasonic waves. For this purpose, the radiating surface of the means of transmitting ultrasonic waves is configured so that it corresponds essentially to the surface of the reaction space or, when the reaction space is a section of a flow-through reaction channel, extends essentially over the entire width of the channel and so that the depth of the reaction space essentially perpendicular to the radiating surface is less than the maximum depth of action of the ultrasound transmitting means.

Here, the term “depth of the reaction space” is essentially the distance between the radiating surface of the ultrasound transmitting means and the bottom of the reaction space.

Preference is given to reaction space depths of up to 100 mm. The depth of the reaction space should advantageously be not more than 70 mm and particularly advantageously not more than 50 mm. The reaction spaces can in principle also have a very small depth, but with a view to a very low risk of blockage and ease of cleaning and also a high product throughput, preference is given to reaction space depths which are substantially greater than, for example, the customary slit heights in high-pressure homogenizers and are usually above 10 mm. The depth of the reaction space can advantageously be altered, for example by ultrasound transmission means extending to different depths into the housing.

In a first embodiment of this apparatus, the radiating surface of the means'for transmitting ultrasound corresponds essentially to the surface of the reaction space. This embodiment is employed for batchwise production of the miniemulsioris used according to the invention. By means of this device, ultrasound can act on the entire reaction space. In the reaction space, turbulent flow is generated by the axial acoustic radiation pressure and effects intensive transverse mixing.

In a second embodiment, such an apparatus has a flow-through cell. Here, the housing is configured as a flow-through reaction channel which has an inlet and an outlet, with the reaction space being a section of the flow-through reaction channel. The width of the channel is the channel dimension running essentially perpendicular to the flow direction. Here, the radiating surface covers the entire width of the flow channel perpendicular to the flow direction. The length of the radiating surface perpendicular to this width, i.e. the length of the radiating surface in the flow direction, defines the region over which the ultrasound acts. In an advantageous variant of this first embodiment, the flow-through reaction channel has an essentially rectangular cross section. If a likewise rectangular ultrasound transmission means having corresponding dimensions is installed in one side of the rectangle, particularly effective and uniform sonication is ensured. However, owing to the turbulent flow conditions prevailing in the ultrasonic field, it is also possible to use, for example, a round transmission means without disadvantages. In addition, a plurality of separate transition means arranged in series in the flow direction can also be provided instead of a single ultrasound transmitting means. Here, both the radiating surfaces and also the depth of the reaction space, i.e. the distance between the radiating surface and the bottom of the flow-through channel, can vary.

The means of transmitting ultrasonic waves is particularly advantageously configured as an ultrasonic probe whose end facing away from the free radiating surface is coupled with an ultrasonic transducer. The ultrasonic waves can be generated, for example, by exploiting the reverse piezoelectric effect. Here, high-frequency electric oscillations (usually in the range from 10 to 100 kHz, preferably from 20 to 40 kHz) are generated by means of generators, converted by means of a piezoelectric transducer into mechanical vibrations of the same frequency and injected by means of the ultrasonic probe as transmitting element into the medium to be sonicated.

The ultrasonic probe is particularly preferably configured as a rod-like, axially radiating λ/2 (or a multiple of λ/2) longitudinal oscillator. Such an ultrasonic probe can, for example, be fixed in an opening of the housing by means of a flange provided at one of its vibration nodes. The conduit for the ultrasonic probe into the housing can in this way be made pressure-tight so that sonication can also be carried out under superatmospheric pressure in the reaction space. The amplitude of vibration of the ultrasonic probe can preferably be regulated, i.e. the amplitude of vibration set in each case is checked on-line and optionally automatically adjusted. The checking of the actual amplitude of vibration can, for example, be carried out by means of a piezoelectric transducer brought into contact with the ultrasonic probe or a strain gauge having downstream evaluation electronics.

In a further advantageous embodiment of such apparatuses, internals for improving the flow and mixing behavior are provided in the reaction space. These internals can be, for example, simple deflection plates or various types of porous bodies.

If necessary, mixing can also be intensified further by means of an additional agitator. The reaction space can advantageously be temperature-controlled.

A process as is disclosed in WO-A 2006/053712, page 3, line 13 to page 6, line 24 can likewise be employed for the advantageous production of a monomer miniemulsion. This process is expressly incorporated by reference into the present text.

From what has been said above it is clear that, according to the invention, only organic solvents OS and/or monomers MON whose solubility in the aqueous medium under polymerization conditions is low enough for, at the amounts indicated, solvent and/or monomer droplets of ≦1500 nm to be formed as a separate phase can be used.

The average diameters of the monomer droplets in the monomer miniemulsion after process step b) are ≦1500 nm, advantageously ≧100 and ≦1300 nm and particularly advantageously ≧120 and ≦900 nm.

In the present text, the terms monomer macroemulsion and monomer miniemulsion of course also comprise the macroemulsions and miniemulsions of the corresponding monomer MON/solvent OS mixtures.

The average diameters of the monomer droplets are for the purposes of the present text basically determined by the principle of pseudoelastic dynamic light scattering at room temperature (with the z-average droplet diameter d_{z} of the unimodal analysis of the autocorrelation function being reported) and measured by means of a Coulter N4 Plus Particle Analyser from Coulter Scientific Instruments. The measurements are carried out on diluted aqueous monomer (mini/macro)emulsions whose content of dispersed constituents is from about 0.005 to 0.01% by weight. Dilution is carried out by means of deionized water which has been saturated beforehand at room temperature with the monomers MON and optionally organic solvents OS vvhich have a low solubility in water comprised in the aqueous monomer (mini/macro)emulsion. The latter measure is to prevent the dilution being accompanied by a change in the droplet diameter.

In a vessel,
c)
c1) any remaining amount of the water,
c2) any remaining amount of the at least one dispersant DP,
c3) any remaining amount of the at least one monomer MON,
c4) any remaining amount of the organic solvent OS and
c5) the total amount of the metal-carbene complex C are then added to the resulting monomer miniemulsion at polymerization temperature and the at least one monomer M is polymerized to a monomer conversion of ≧80% by weight, advantageously ≧90% by weight and particularly advantageously ≧95% by weight.

The reaction steps c1) to c5) here do not necessarily represent an order so that it can also be advantageous, depending on the metal-carbene complex C or the monomers MON to be polymerized, firstly to add the total amount of the metal complex C according to c5) at polymerization temperature to the monomer miniemulsion obtained in process step b) and only then introduce any remaining amount of water according to c1), dispersants DP according to c2), monomers MON according to c3) and/or solvents OS according to c4) either discontinuously or continuously at a uniform or changing flow rate.

However, it is advantageous for the total amount of the metal-carbene complex C firstly to be dissolved in part of the water and the resulting aqueous metal-carbene complex solution then to be added to the monomer miniemulsion in process step c5) with intensive mixing.

For the purposes of the present invention, it goes without saying that the process steps of subgroups a), b) and c) can be carried out in one and the same vessel or in different vessels.

According to the invention, the polymerization temperature is ≧0 and ≦150° C., advantageously ≧10 and ≦100° C. and particularly advantageously ≧20 and ≦90° C. If the polymerization temperature is ≧100° C., it is advantageous for the pressure of the atmosphere above the aqueous polymerization medium to be high enough (>1 atm absolute) for disadvantageous boiling of the polymerization mixture to be suppressed. An important aspect here is that the ammonium complexes according to the invention based on the complexes 3 and 4 are particularly active at a temperature of ≧50° C. and preferably at a temperature of ≧80° C., resulting in high ROMP reaction rates. Particularly on an industrial scale, these reaction temperatures have the advantage that the reaction energy liberated in the ROMP reaction can be removed in a simple way by means of conventional cooling water; highly energy-consuming cooling brines having temperatures of <0° C. or expensive liquefied gases are not required.

Owing to the oxygen sensitivity of the metal-carbene complexes C, handling of the metal-carbene complexes C themselves and also the polymerization reaction are advantageously carried out under an oxygen-free inert gas atmosphere, for example under a nitrogen or argon atmosphere.

According to the invention, the molar ratio of monomer MON to the metal ion complex C is advantageously ≧1000, in particular ≧5 000 and particularly advantageously ≧10 000.

It is likewise advantageous, according to the invention, for the pH of the aqueous polymerization medium to be ≦6, in particular ≦5 and particularly advantageously ≦4, during and after the addition of the metal-carbene complex C in process step c5). The pH is adjusted by means of customary dilute acids or bases which do not interfere, for example sulfuric acid, phosphoric acid, hydrochloric acid, ammonium hydroxide or sodium or potassium hydroxide. The pH values are measured at from 20 to 25° C. (room temperature) using a calibrated pH meter.

Apart from the abovementioned components, further customary auxiliaries such as biocides, thickeners, antifoams, buffering substances, etc., can optionally be added to the monomer macroemulsion, the monomer miniemulsion and/or the aqueous polymer dispersion according to the invention.

The polymerization reaction according to the invention to form an aqueous polymer dispersion generally proceeds very rapidly, with the monomer conversion being able to be monitored in a manner familiar to those skilled in the art, for example by means of a reaction calorimeter.

Stable aqueous polymer dispersions can be obtained within short polymerization times and under mild polymerization conditions by the process of the invention.

Of course, the aqueous polymer dispersions according to the invention which can be obtained by the process of the invention can be used for producing adhesives, sealants, polymer plasters and renders, paper coatings, fiber nonwovens, paints and impact modifiers and also for the consolidation of sand, textile finishing, leather finishing or for modifying mineral binders and plastics.

Furthermore, the corresponding polymer powders can be obtained in a simple way (for example freeze drying or spray drying) from the aqueous polymer dispersions of the invention. These polymer powders which can be obtained according to the invention can likewise be used for producing adhesives, sealants, polymer plasters and renders, paper coatings, fiber nonwovens, paints and impact modifiers and also for the consolidation of sand, textile finishing, leather finishing or for modifying mineral binders and plastics.

The invention is illustrated by the nonlimiting examples below.

### EXAMPLES

I Preparation of the Complexes

### I.1 Preparation of the Complexes 1 and 2

### I.1.1 Preparation of dichlorobis(tricyclohexylphosphine)benzylideneruthenium(II) (5)

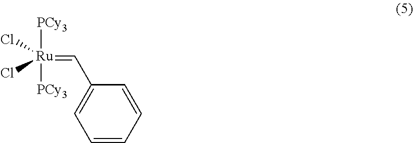

The preparation of the dichloro compound 5 was carried out as described in example 9 of U.S. Pat. No. 5,912,376. In the structural formulae of the examples, “Cy” is a cyclohexyl radical.

### I.1.2 Preparation of dichloro-1,3-bis(2,6-dimethyl-4-dimethylaminophenyl)imidazolidin-2-ylidenetricyclohexylphosphinebenzylideneruthenium(II) (6)

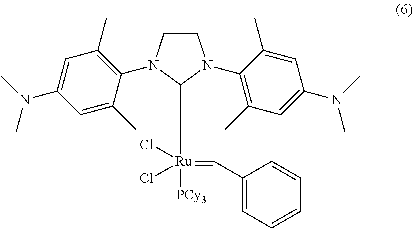

Starting out from the dichloro compound 5, the preparation of the ruthenium complex 6 was carried out as described in S. L. Balof, S. J. P'Pool, N. J. Berger, E. J. Valente, A. M. Shiller, H.-J. Schanz, Dalton Trans., 2008, pages 5791 to 5799.

### I.1.3 Preparation of dichloro-1,3-bis(2,6-dimethyl-4-dimethylaminophenyl)imidazolidin-2-ylidenebis(4-dimethylaminopyridine)benzylideneruthenium(II) (1)

488 mg (4.00 mmol) of 4-dimethylaminopyridine (DMAP) were added to a suspension composed of 1232 mg (1.36 mmol) of dichloro-1,3-bis(2,6-dimethyl-4-dimethylaminophenypimidazolidin-2-ylidenetricyclohexylphosphinebenzylideneruthenium(II) (6) and 50 ml of tert-butyl methyl ether and the mixture obtained was stirred at room temperature (20 to 25° C.) under a nitrogen atmosphere for 16 hours. During this time, a light-green precipitate separated out and the initially light-brown supernatant solution became decolorized. The precipitate obtained was subsequently filtered off in air and washed once with 20 ml of a 1 millimolar (0.122 g/l) DMAP/tert-butyl methyl ether solution. The filter residue obtained was subsequently dried at 60° C. and 30 mbar (absolute) in a vacuum oven for 4 hours. This gave 1065 mg (1.22 mmol, corresponding to a yield of 90 mol %) of complex 1 {NMR-spectroscopic characterization: ¹H NMR (300.1 MHz, C₆D₆, 20° C.): δ 19.81 (s, Ru═CH), 8.57 (d, ³J[¹H¹H]=7.2 Hz, 2H), 7.23 (t, ³J[¹H¹H]=8.4 Hz, 1H), 7.01 (m, 2H, ═CH—C₆H₅), 8.29 (d, ³J[¹H¹H]=7.5 Hz, 2H), 8.18 (d, ³J[¹H¹H]=6.3 Hz, 2H), 6.08 (d, ³J[¹H¹H]=7.5 Hz, 2H), 5.43 (d, ³J[¹H¹H]=6.3 Hz, 2H, 2×C₅NH₄), 6.59 (s, 2H), 6.34 (s, 2H, 2×C₆H₂), 3.57 (m, 2H), 3.48 (m, 2H, CH₂—CH₂), 3.01 (s, 6H), 2.61 (s, 6H), 2.58 (s, 6H), 2.54 (s, 6H, 4×N(CH₃)₂), 2.20 (s, 6H), 1.80 (s, 6H, 2×C₆H₂(CH₃)₂); ¹³C {¹H} NMR (75.9 MHz, d₆-benzene, 20° C.): δ 309.8 (Ru═CH), 221.2 (N—C—N), 153.7, 153.5, 152.5 (2 signals), 152.1, 150.5 (2 signals), 150.4, 140.8, 138.7, 130.9, 130.6, 128.9, 128.6, 113.1, 112.6, 106.7, 106.2 (aryl-C), 51.9, 51.1 (N—CH₂—CH₂—N), 40.5, 40.3, 38.2, 37.8 (N—CH₃), 21.7, 19.6 (C₆H₂(CH₃)₂)}.

### I.1.4 Preparation of 1,3-bis(2,6-dimethyl-4-dimethylaminophenyl)imidazolium chloride (7)

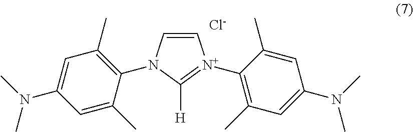

501 mg (15.0 mmol) of paraformaldehyde were added at 75° C. to a solution of 3556 mg (10.16 mmol) of glyoxal bis(2,6-dimethyl-4-dimethylaminophenyl)imine (prepared as described in S. L. Balof, S. J. P'Pool, N. J. Berger, E. J. Valente, A. M. Shiller, H.-J. Schanz, Dalton Trans., 2008, pages 5791 to 5799) and 100 ml of ethyl acetate and the mixture obtained was stirred for 5 minutes. A solution of 1352 mg (12.5 mmol) of trimethylsilyl chloride in 50 ml of ethyl acetate was subsequently added continuously at a constant flow rate to the resulting mixture at a constant temperature over a period of 8 hours while stirring. During this time, a light-colored precipitate was formed. The reaction mixture was stirred at 75° C. for a further 12 hours. The suspension obtained was then cooled to room temperature and the precipitate was filtered off. The filter residue obtained was washed twice with 30 ml of ethyl acetate and subsequently dried at 60° C. and 30 mbar (absolute) in a vacuum oven for 16 hours. This gave 3435 mg (8.61 mmol, 85 mol % yield) of the ligand compound 7 {NMR-spectroscopic characterization: ¹H NMR (300.1 MHz, CDCl₃, 20° C.): δ 10.09 (t, ³J[¹H¹H]=1.5 Hz, 1H), 7.67 (d, ³J[¹H¹H]=1.5 Hz, 2H, C₃H₃N₂), 6.46 (s, 4H, 2×C₆H₂), 3.00 (s, 12H, 2×N(CH₃)₂), 2.17 (s, 12H, 2×C₆H₂(CH₃)₂); ¹³C {¹H} NMR (75.9 MHz, CDCl₃, 20° C.): δ 151.3, 138.9, 121.8, 111.6 (C₆H₂), 134.7, 125.3 (C₃H₃N₂), 40.2 (N(CH₃)₂), 18.2 (C₆H₂(CH₃)₂)}.

### I.1.4 Preparation of dichloro-1,3-bis(2,6-dimethyl-4-dimethylaminophenyl)imidazolin-2-ylidene(tricyclohexylphosphine)benzylideneruthenium(II) (8)

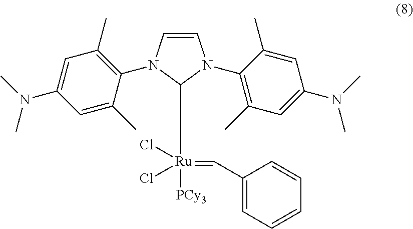

303 mg (0.76 mmol) of ligand compound 7 and 93 mg (0.83 mmol) of potassium tert-butoxide and also 40 ml of n-heptane were placed under a nitrogen atmosphere in a Schlenk flask. The Schlenk flask was subsequently dipped in a water bath having a temperature of 60° C., subatmospheric pressure was applied until the contents of the flask began to boil, the stopcock to the vacuum line was then closed and the contents of the flask were stirred under these conditions for 60 minutes. After cooling to room temperature, the subatmospheric pressure in the Schlenk flask was broken by admission of nitrogen, 400 mg (0.49 mmol) of dichlorobis(tricyclohexylphosphine)-benzylideneruthenium(II) (5) were added to the resulting mixture under a nitrogen atmosphere and the flask was closed by means of a septum. The Schlenk flask was subsequently dipped again into a water bath having a temperature of 60° C., subatmospheric pressure was applied until the contents of the flask began to boil, the stopcock to the vacuum line was then closed and the reaction mixture obtained was stirred under these conditions for 24 hours. During this time, an orange-brown precipitate was formed. The contents of the Schlenk flask were subsequently cooled to room temperature and the solvent was removed by application of subatmospheric pressure (0.1 mbar absolute; 30 minutes). The Schlenk flask was then brought to atmospheric pressure by means of the ambient air atmosphere and 50 ml of a water/isopropanol mixture (1:1 v/v) were added. The Schlenk flask was subsequently introduced into an ultrasonic bath for 30 minutes to disperse the precipitate and the suspension obtained was then filtered. The filter residue obtained was washed twice with 30 ml of a water/isopropanol mixture (1:1 v/v) and twice with 10 ml of methanol and subsequently dried at 60° C. and 30 mbar (absolute) in a vacuum oven for 12 hours. This gave 379 mg (0.42 mmol, 86 mol % yield) of the complex 8 as an orange-brown powder {NMR-spectroscopic characterization: ¹H NMR (300.1 MHz, 20° C., C₆D₆): δ 20.01 (s, Ru═CH), 7.19 (br. m, 1H), 7.12 (br. m, 2H, ═CH—C₆H₅), 7.02 (br. m, 2H), 6.53 (br. s, 4H, C₆H₂), 6.35 (m, 1H), 6.30 (m, 1H, N—CH═CH—N), 2.68 (s, 12H, 2×N(CH₃)₂), 2.47 (s, 12H, 2×C₆H₂(CH₃)₂), 2.60 (m, 3H) 1.73 (br. m, 6H), 1.55 (br. m, 9H), 1.12 (br. m, 15H, PCy₃); ¹³C {¹H} NMR (75.9 MHz, CD₂Cl₂, 20° C.): δ 294.7 (br., Ru═CH), 190.4 (d, ²J[³¹J³¹C]=84.8 Hz, N—C—N), 152.1, 150.6, 150.2, 138.8, 137.4, 137.3, 128.9, 128.0, 127.7, 125.3 (2 signals), 124.9, 111.3, 110.7 (s, aryl-C+N—CH═CH—N), 40.1 (2 signals, N—CH₃), 20.2, 18.8 (C₆H₂(CH₃)₂), 31.5 (d, ¹J[³¹P¹³C]=17.2 Hz), 29.4 (br. s), 28.0 (d, ²J[³¹P¹³C]=9.6 Hz), 26.5 (s, PCy₃); ³¹P {¹H} NMR (121.4 MHz, C₆D₆, 20° C.): δ 32.4(s)}.

### I.1.5 Preparation of dichloro-1,3-bis(2,6-dimethyl-4-dimethylaminophenyl)imidazolin-2-ylidenebis(4-dimethylaminopyridine)benzylideneruthenium(II) (2)

165 mg (1.36 mmol) of DMAP were introduced at room temperature and under a nitrogen atmosphere into a flask comprising a suspension composed of 300 mg (0.33 mmol) of dichloro-1,3-bis(2,6-dimethyl-4-dimethylaminophenyl)imidazolin-2-ylidene(tricyclohexylphosphine)benzylideneruthenium(II) (8) and 50 ml tert-butyl methyl ether. The flask comprising the mixture obtained was subsequently introduced into an ultrasonic bath at room temperature for 60 minutes. The contents of the flask were subsequently stirred at room temperature for 16 hours. During this time, a light-green precipitate separated out and the originally light-brown supernatant solution became decolorized. The precipitate was subsequently filtered off in air and washed with 20 ml of a 1 millimolar DMAP/tert-butyl methyl ether solution. The filter residue obtained was subsequently dried at 60° C. and 30 mbar (absolute) in a vacuum oven for 16 hours. This gave 251 mg (0.28 mmol, 84 mol % yield) of complex 2 as a light-green powder {NMR-spectroscopic characterization: ¹H NMR (300.1 MHz, C₆D₆, 20° C.): δ 20.18 (s, 1H, Ru═CH), 8.82 (br., 2H), 7.26 (m, 1H), 7.04 (m, 2H, ═CH—C₆H₅), 8.36 (d, ³J[¹H¹H]=7.5 Hz, 2H), 8.18 (d, ³J[¹H¹H]=7.2 Hz, 2H), 6.00 (d, ³J[¹H¹H]=7.5 Hz, 2H), 5.43 (d, ³J[¹H¹H]=6.3 Hz, 2H, 2×C₅NH₄), 6.50 (s, 2H, N—CH═CH—N), 6.45 (br., 2H), 6.38 (br., 2H, 2×C₆H₂), 2.87 (br. s, 6H), 2.58 (s, 12H), 2.51 (br. s, 6H, 4×N(CH₃)₂), 2.12 (s, 6H), 1.76 (s, 6H, 2×C₆H₂(CH₃)₂)}.

### I.2 Preparation of the Complexes 3 and 4

### I.2.1 Preparation of dichlorobis(tricyclohexylphosphine)(phenylthio)methyleneruthenium(II) (9)

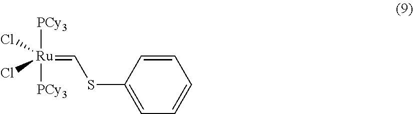

The preparation of the ruthenium complex 9 was carried out as described in example 1 of EP-A 993465.

### I.2.2 Preparation of 1,3-bis(2,6-dimethyl-4-dimethylaminophenyl)imidazolidinium chloride (10)

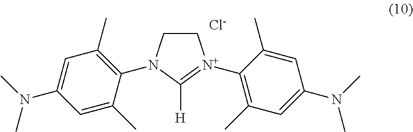

The preparation of the ligand compound 10 was carried out as described in S. L. Balof, S. J. P'Pool, N. J. Berger, E. J. Valente, A. M. Shiller, H.-J. Schanz, Dalton Trans., 2008, pages 5791 to 5799.

### I.2.3 Preparation of dichloro-1,3-bis(2,6-dimethyl-4-dimethylaminophenyl)imidazolidin-2-ylidenetricyclohexylphosphine(phenylthio)methyleneruthenium(II) (11)

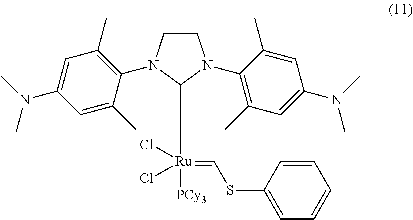

374 mg (0.93 mmol) of ligand compound 10 and 120 mg (1.07 mmol) of potassium tert-butoxide and also 60 ml of n-heptane were introduced under a nitrogen atmosphere into a Schlenk flask. The Schlenk flask was subsequently dipped into a water bath having a temperature of 60° C., subatmospheric pressure was applied until the contents of the flask began to boil, the stopcock to the vacuum line was then closed and the contents of the flask were stirred under these conditions for 60 minutes. After cooling to room temperature, the subatmospheric pressure in the Schlenk flask was broken by admission of nitrogen, 606 mg (0.77 mmol) of ruthenium complex 9 were added to the mixture obtained under a nitrogen atmosphere and the flask was closed by means of a septum. The Schlenk flask was subsequently dipped again into a water bath having a temperature of 60° C., subatmospheric pressure was applied until the contents of the flask began to boil, the stopcock to the vacuum line was then closed and the reaction mixture obtained was stirred under these conditions for 6 days. During this time, a light-pink precipitate was formed. The reaction mixture was then cooled to room temperature and the precipitate formed was filtered off. The precipitate obtained was washed twice with 10 ml each time of n-heptane and subsequently dried at 60° C. and 30 mbar (absolute) in a vacuum oven for 2 hours. The filter residue was suspended in 50 ml of a 3:1 (v/v) mixture of isopropanol and 0.5 molar aqueous ammonium chloride solution in a 100 ml glass flask and the flask was then introduced into an Ultrasonic bath at 30° C. for 60 minutes. The solid was subsequently filtered off from the suspension, the filter residue was washed twice with 10 ml each time of methanol and then dried at 60° C. and 30 mbar (absolute) in a vacuum oven for 3 hours. This gave 474 mg (0.50 mmol, 65 mol % yield) of the ruthenium complex 11 {NMR-spectroscopic characterization: ¹H NMR (300.1 MHz, C₆D₆, 20° C.): δ 17.98 (s, Ru═CH), 7.21 (d, ³J[¹H¹H]=7.2 Hz, 2H), 6.97 (t, ³J[¹H¹H]=8.4 Hz, 1H), 6.88 (m, 2H, ═CH—C₆H₅), 6.50 (s, 2H), 6.13 (s, 2H, 2×C₆H₂), 3.35 (m, 4H, CH₂—CH₂), 2.90 (s, 6H), 2.75 (s, 6H, 2×N(CH₃)₂), 2.60 (s, 6H), 2.28 (s, 6H, 2×C₆H₂(CH₃)₂), 2.57 (br., m, 3H), 1.88 (br., m, 6H), 1.65 (br., m, 6H), 1.55 (br., m, 3H), 1.45-1.02 (br., m, 18H, PCy₃); ¹³C {¹H} NMR (75.9 MHz, C₆D₆, 20° C.): δ 272.2 (br., Ru═CH), 219.4 (d, ²J[³¹P¹³C]=81.6 Hz, N—C—N), 150.5, 149.5, 141.8, 140.4, 138.6, 129.3, 128.7, 126.5, 125.5, 125.4, 112.7, 111.9 (s, aryl-C), 52.3, 52.1 (s, N—CH₂—CH₂—N), 40.5, 40.3, 40.0, 39.6 (N—CH₃), 21.0, 20.0 (C₆H₂(CH₃)₂), 32.3 (d, ¹J[³¹P¹³C]=15.6 Hz), 29.7 (s), 28.1 (d, ²J[³¹P¹³C]=10.2 Hz), 26.7 (s, PCy₃); ³¹P {¹H} NMR (121.4 MHz, C₆D₆, 20° C.): δ 23.4 (s)}.

### I.2.4 Preparation of dichloro-1,3-bis(2,6-dimethyl-4-dimethylaminophenyl)imidazolidin-2-ylidenebis(4-dimethylaminopyridine)(phenylthio)methyleneruthenium(II) (3)

412 mg (3.38 mmol) of DMAP were introduced at room temperature and under a nitrogen atmosphere into a flask comprising a suspension composed of 1237 mg (1.32 mmol) of ruthenium complex 11 and 50 ml of tert-butyl methyl ether. The flask comprising the mixture obtained was subsequently introduced into an ultrasonic bath at 30° C. for 2 hours. The contents of the flask were subsequently stirred at room temperature for a further 16 hours. During this time, a gray-green precipitate separated out and the initially light-brown supernatant solution became decolorized. The precipitate was subsequently filtered off in air and washed with 20 ml of a 1 millimolar DMAP/tert-butyl methyl ether solution. The filter residue obtained was subsequently dried at 60° C. and 30 mbar (absolute) in a vacuum oven for 2 hours. This gave 1110 mg (1.23 mmol, 93% by weight yield) of complex 3 as a gray-green powder {NMR-spectroscopic characterization: ¹H NMR (300.1 MHz, CDCl₃, 20° C.): δ 17.33 (s, Ru═CH), 8.26 (br., 2H), 7.16 (br., 2H), 6.49 (br., 2H), 6.22 (br., 2H, 2×C₅NH₄), 6.47 (s, 2H), 6.15 (s, 2H, 2×C₆H₂), 0, 7.13 (m, 5H, S—C₆H₅), 4.11 (m, 2H), 3.98 (m, 2H, CH₂—CH₂), 3.00 (s, 6H), 2.96 (s, 6H), 2.90 (s, 6H), 2.69 (s, 6H, 4×N(CH₃)₂), 2.60 (s, 6H), 2.40 (s, 6H, 2×C₆H₂(CH₃)₂)}. The crystal structure shown in FIG. 1 having the following crystal and structure data was determined by means of X-ray structure analysis (MoK_{α} radiation using a charge coupled detector (CCD), measuring instrument: Oxford Diffraction Systems Gemini S).

Crystal and Structure Data for Complex 3

| | |
|---|---|
| Temperature [K] | 300(2) |
| Wavelength [Å] | 0.71073 |
| Crystal system | triclinic |
| Dimensions [Å] | a = 10.2523(5) |
| | b = 12.3752(6) |
| | c = 18.3356(9) |
| Volume [Å³] | 2275.91(19) |
| Z; calculated density [mg m⁻³] | 2; 1.344 |
| Absorption coefficient [m m⁻¹] | 0.550 |
| F(000) | 964 |
| R value [I > 2sigma(I)] | R1 = 0.0555, |
| | wR2 = 0.0925 |
| R value (all data) | R1 = 0.1525, |
| | wR2 = 0.0987 |

Selected Bond Lengths [Å]

| | |
|---|---|
| S—C(1) | 1.721(3) |
| S—C(2) | 1.771(4) |
| Ru—C(1) | 1.849(3) |
| Ru—C(15) | 2.031(3) |
| Ru—N(7) | 2.184(3) |
| Ru—N(1) | 2.272(3) |
| Ru—Cl(1) | 2.4132(9) |
| Ru—Cl(2) | 2.4255(9) |

Selected Bond Angles [Degrees]

| | |
|---|---|
| C(1)—S—C(2) | 105.61(17) |
| C(1)—Ru—C(15) | 96.05(13) |
| C(1)—Ru—N(7) | 86.23(12) |
| C(15)—Ru—N(7) | 177.13(13) |
| C(1)—Ru—N(1) | 163.82(10) |
| C(15)—Ru—N(1) | 99.26(11) |
| N(7)—Ru—N(1) | 78.32(10) |
| C(1)—Ru—Cl(1) | 92.79(10) |
| C(15)—Ru—Cl(1) | 92.20(9) |
| N(7)—Ru—Cl(1) | 89.44(8) |
| N(1)—Ru—Cl(1) | 91.83(7) |
| C(1)—Ru—Cl(2) | 86.46(10) |
| C(15)—Ru—Cl(2) | 87.84(9) |
| N(7)—Ru—Cl(2) | 90.55(8) |
| N(1)—Ru—Cl(2) | 88.90(7) |
| Cl(1)—Ru—Cl(2) | 179.25(4) |
| S—C(1)—Ru | 128.00(19) |

### I.2.5 Preparation of dichloro-1,3-bis(2,6-dimethyl-4-dimethylaminophenyl)imidazolin-2-ylidene(tricyclohexylphosphine)(phenylthio)methyleneruthenium(II) (12)

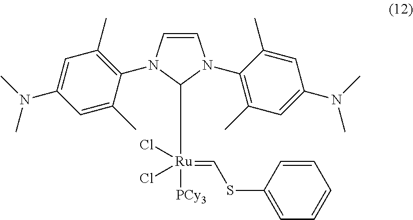

599 mg (1.50 mmol) of ligand compound 7 and 193 mg (1.72 mmol) of potassium tert-butoxide and also 60 ml of n-heptane were placed under a nitrogen atmosphere in a Schlenk flask. The Schlenk flask was subsequently dipped in a water bath having a temperature of 80° C., subatmospheric pressure was applied until the contents of the flask began to boil, the stopcock to the vacuum line was then closed and the contents of the flask were stirred under these conditions for 90 minutes. After cooling to room temperature, the subatmospheric pressure in the Schlenk flask was broken by admission of nitrogen, 992 mg (1.16 mmol) of the ruthenium complex 9 were added to the mixture obtained under a nitrogen atmosphere and the flask was closed by means of a septum. The Schlenk flask was subsequently dipped again into a water bath having a temperature of 60° C., subatmospheric pressure was applied until the contents of the flask began to boil, the stopcock to the vacuum line was then closed and the reaction mixture obtained was stirred under these conditions for 4 days. During this time, a pink-brown precipitate was formed. The reaction mixture was subsequently cooled to room temperature, the precipitate formed was filtered off, the filter residue obtained was washed twice with 10 ml each time of n-heptane and subsequently dried at 60° C. and 30 mbar (absolute) in a vacuum oven for 2 hours. The filter residue was then suspended in 50 ml of methanol in a 100 ml glass flask and the flask was then introduced into an ultrasonic bath at room temperature for 30 minutes. The solid was subsequently filtered off from the suspension, the filter residue was washed twice with 10 ml each time of methanol and then dried at 60° C. and 30 mbar (absolute) in a vacuum oven for 3 hours. This gave 820 mg (0.91 mmol, 78 mol % yield) of the ruthenium complex 12 as a pink powder {NMR-spectroscopic characterization: ¹H NMR (300.1 MHz, C₆D₆, 20° C.): δ 18.21 (s, Ru═CH), 7.25 (d, ³J[¹H¹H]=7.5 Hz, 2H), 6.99 (t, ³J[¹H¹H]=7.5 Hz, 2H), 6.89 (t, ³J[¹H¹H]=7.5 Hz, 1H, ═CH—C₆H₅), 6.48 (s, 2H), 6.11 (s, 2H, 2×C₆H₂), 6.29 (m, 1H), 6.27 (m, 1H, N—CH═CH—N), 2.73 (s, 3H), 2.60 (s, 3H), 2.57 (s, 3H), 2.28 (s, 3H , 2×N(CH₃)₂+2×C₆H₂(CH₃)₂), 2.61 (br., m, 3H), 1.93 (br., m, 6H), 1.64 (br., m, 6H), 1.52 (br., m, 3H), 1.45-1.08 (br., m, 18H, PCy₃); ¹³C {¹H} NMR (75.9 MHz, C₆D₆, 20° C.): δ 272.6 (br., Ru═CH), 189.5 (d, ²J[³¹P¹³C]=87.6 Hz, N—C—N), 150.8, 150.0, 141.9, 139.3, 138.0, 129.2, 128.7, 127.1, 125.6, 125.4, 124.9, 124.8, 112.0, 111.3 (s, aryl-C+N—CH═CH—N), 39.9, 39.5, (N—CH₃), 20.7, 19.8 (C₆H₂(CH₃)₂), 32.5 (d, ¹J[³¹P¹³C]=16.1 Hz), 29.8 (s), 28.1 (d, ²J[³¹P¹³C]=10.2 Hz), 26.7 (s, PCy₃); ³¹P {¹H} NMR (121.4 MHz, C₆D₆, 20° C.): δ 26.0 (s)}.

### I.2.6 Preparation of dichloro-1,3-bis(2,6-dimethyl-4-dimethylaminophenyl)imidazolin-2-ylidenebis(4-dimethylaminopyridine)(phenylthio)methyleneruthenium(II) (4)

244 mg (2.00 mmol) of DMAP were introduced at room temperature and under a nitrogen atmosphere into a flask comprising a suspension composed of 601 mg (0.64 mmol) of ruthenium complex 12 and 30 ml of tert-butyl methyl ether. The flask comprising the mixture obtained was subsequently introduced into an ultrasonic bath at 30° C. for two hours. The contents of the flask were subsequently stirred at room temperature for a further 16 hours. During this time, a light-green precipitate separated out and the initially light-brown supernatant solution became decolorized. The precipitate was subsequently filtered off and washed with 10 ml of a 1 millirnolar DMAP/tert-butyl methyl ether solution. The filter residue obtained was subsequently dried at 60° C. and 30 mbar (absolute) in a vacuum oven for 2 hours. This gave 498 mg (0.55 mmol, 86 mol % yield) of complex 3 as a light-green powder {NMR-spectroscopic characterization: ¹H NMR (300.1 MHz, CDCl₃, 20° C.): δ 17.68 (s, 1H, Ru═CH), 7.17 (m, 5H, S—C₆H₅), 6.85 (br., 2H, N—CH═CH—N), 8.61 (br., 2H), 8.03 (br., 2H), 6.09 (br., 8H, 2×C₅NH₄+2×C₆H₂), 2.93 (br., 12H), 2.77 (br., 6H), 2.65 (br., 6H, 4×N(CH₃)₂), 2.27 (br., 12H, 2×C₆H₂(CH₃)₂)}.

### I.3 Preparation of dichloro-1,3-bis(2,4,6-trimethylphenyl)imidazolidin-2-ylidenebis(3-brompyridine)benzylideneruthenium(II) (13) as comparative complex

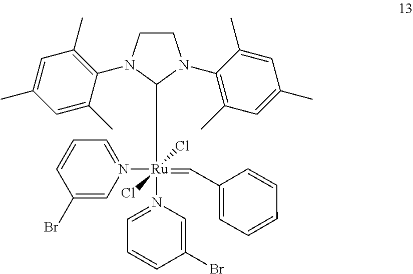

The preparation of the comparative ruthenium complex 13 was carried out as described in U.S. Pat. No. 6,759,537, column 32.

### II Preparation of the Aqueous Polymer Dispersions

### II.1 Polymer Dispersion 1

A mixture comprising 73.1 g of deionized water and 8.3 g of a 10% by strength aqueous solution of a C₁₆C₁₈-fatty alcohol polyethoxylate (Emulgin® B3 from COGNIS GmbH), 0.75 g (3.3 mmol) of n-hexadecane and 15.3 g (115.9 mmol) of dicyclopentadiene (98% strength by weight) was weighed at 20-25° C. (room temperature) under a nitrogen atmosphere into a 150 ml glass flask provided with a magnetic stirrer bar and the mixture was stirred vigorously for one hour to form a homogeneous monomer macroemulsion. The monomer macroemulsion formed was subsequently homogenized by means of an ultrasonic processor UP 400s (ultrasonic probe H7, 100% power) for a time of five minutes. The monomer miniemulsion formed had an average droplet diameter of 305 nm.

The aqueous monomer miniemulsion obtained was subsequently transferred under a nitrogen atmosphere into a heatable 500 ml glass flask equipped with stirrer, thermometer, reflux condenser and feed vessels and heated to 35° C. while stirring. In parallel thereto, 20.6 mg (0.023 mmol) of ruthenium complex 3 was dissolved in 13.6 g of a 0.1 molar aqueous hydrochloric acid solution to form the corresponding dimethylammonium compound. While stirring and maintaining the temperature, the abovementioned dimethylammonium complex was added over a period of one minute to the monomer miniemulsion and the polymerization mixture obtained was stirred for 2 hours at this temperature. The aqueous polymer dispersion obtained was subsequently cooled to room temperature and filtered through a 20 μm filter. The dispersion had a coagulum content of 0.1% by weight.

The aqueous polymer dispersion obtained had a solids content of 14.3% by weight. The average particle size was found to be 315 nm.

The solids contents were generally determined by drying a defined amount of the aqueous polymer dispersion (about 0.8 g) to constant weight at a temperature of 130° C. by means of a moisture meter HR73 from Mettler Toledo (approx. 2 hours). Two measurements were carried out in each case. The values reported are the means of these measurements.

The z-average droplet diameter of the aqueous monomer miniemulsions and the average particle diameter of the polymer particles were generally determined by dynamic light scattering on a 0.005-0.01 percent strength by weight aqueous dispersion at 23° C. by means of an Autosizer IIC from Malvern Instruments, GB. The value reported is the average diameter of the cumulant z average of the measured autocorrelation function (ISO standard 13321).

### II.2 Polymer Dispersion 2

The preparation of the polymer dispersion 2 was carried out in a manner fully analogous to the preparation of the polymer dispersion 1, except that a solution composed of 20.1 mg (0.023 mmol) of ruthenium complex 1 and 13.6 g of a 0.1 molar aqueous hydrochloric acid solution was used instead of the corresponding ruthenium complex 3 solution.

The aqueous polymer dispersion obtained had a solids content of 14.8% by weight and a coagulum content of 0.4% by weight. The average particle size was found to be 269 nm.

### II.3 Polymer Dispersion 3

The preparation of the polymer dispersion 3 was carried out in a manner fully analogous to the preparation of the polymer dispersion 1, except that a solution composed of 20.1 mg (0.023 mmol) of ruthenium complex 2 and 13.6 g of a 0.1 molar aqueous hydrochloric acid solution was used instead of the corresponding ruthenium complex 3 solution.

The aqueous polymer dispersion obtained had a solids content of 14.6% by weight and a coagulum content of 0.4% by weight. The average particle size was found to be 295 nm.

### II.4 Polymer Dispersion 4

The preparation of the polymer dispersion 4 was carried out in a manner fully analogous to the preparation of the polymer dispersion 1, except that a solution composed of 20.6 mg (0.023 mmol) of ruthenium complex 4 and 13.6 g of a 0.1 molar aqueous hydrochloric acid solution was used instead of the corresponding ruthenium complex 3 solution.

The aqueous polymer dispersion obtained had a solids content of 14.2% by weight and a coagulum content of 0.1% by weight. The average particle size was found to be 267 nm.

### II.5 Polymer Dispersion 5

The preparation of polymer dispersion 5 was carried out in a manner fully analogous to the preparation of polymer dispersion 1, except that the reaction temperature was 65° C. instead of 35° C. and the reaction time was only 1 hour.

The aqueous polymer dispersion obtained had a solids content of 15.1% by weight and a coagulum content of 0.1% by weight. The average particle size was found to be 264 nm.

### II.6 Polymer Dispersion 6

The preparation of polymer dispersion 6 was carried out in a manner fully analogous to the preparation of polymer dispersion 2, except that the reaction temperature was 65° C. instead of 35° C.

The aqueous polymer dispersion obtained had a solids content of 15.1% by weight and a coagulum content of 1.0% by weight. The average particle size was found to be 278 nm.

### II.7 Polymer Dispersion 7

The preparation of polymer dispersion 7 was carried out in a manner fully analogous to the preparation of polymer dispersion 3, except that the reaction temperature was 55° C. instead of 35° C.

The aqueous polymer dispersion obtained had a solids content of 15.0% by weight and a coagulum content of 0.9% by weight. The average particle size was found to be 285 nm.

### II.8 Polymer Dispersion 8

The preparation of polymer dispersion 8 was carried out in a manner fully analogous to the preparation of polymer dispersion 4, except that the reaction temperature was 65° C. instead of 35° C. and the reaction time was only 1 hour.

The aqueous polymer dispersion obtained had a solids content of 14.9% by weight and a coagulum content of 0.2% by weight. The average particle size was found to be 260 nm.

### II.9 Polymer Dispersion 9

The preparation of polymer dispersion 9 was carried out in a manner fully analogous to the preparation of polymer dispersion 1, except that a mixture of 8.4 g (63.5 mmol) of dicyclopentadiene and 7.2 g (65.3 mmol) of cis-cyclooctene was used instead of 15.3 g of dicyclopentadiene.

The aqueous polymer dispersion obtained had a solids content of 13.4% by weight and a coagulum content of 0.1% by weight. The average particle size was found to be 255 nm.

### II.10 Polymer Dispersion 10

The preparation of polymer dispersion 10 was carried out in a manner fully analogous to the preparation of polymer dispersion 2, except that a mixture of 8.4 g (63.5 mmol) of dicyclopentadiene and 7.2 g (65.3 mmol) of cis-cyclooctene was used instead of 15.3 g of dicyclopentadiene.

The aqueous polymer dispersion obtained had a solids content of 14.8% by weight and a coagulum content of 0.4% by weight. The average particle size was found to be 270 nm.

### II.11 Polymer Dispersion 11

The preparation of polymer dispersion 11 was carried out in a manner fully analogous to the preparation of polymer dispersion 3, except that a mixture of 8.4 g (63.5 mmol) of dicyclopentadiene and 7.2 g (65.3 mmol) of cis-cyclooctene was used instead of 15.3 g of dicyclopentadiene.

The aqueous polymer dispersion obtained had a solids content of 12.6% by weight and a coagulum content of 0.3% by weight. The average particle size was found to be 254 nm.

### II.12 Polymer Dispersion 12

The preparation of polymer dispersion 12 was carried out in a manner fully analogous to the preparation of polymer dispersion 4, except that a mixture of 8.4 g (63.5 mmol) of dicyclopentadiene and 7.2 g (65.3 mmol) of cis-cyclooctene was used instead of 15.3 g of dicyclopentadiene.

The aqueous polymer dispersion obtained had a solids content of 12.1% by weight and a coagulum content of 0.2% by weight. The average particle size was found to be 265 nm.

### II.13 Polymer Dispersion 13

The preparation of polymer dispersion 13 was carried out in a manner fully analogous to the preparation of polymer dispersion 9, except that the reaction temperature was 65° C. instead of 35° C. and the reaction time was only 1 hour.

The aqueous polymer dispersion obtained had a solids content of 14.8% by weight and a coagulum content of 0.1% by weight. The average particle size was found to be 290 nm.

### II.14 Polymer Dispersion 14

The preparation of polymer dispersion 14 was carried out in a manner fully analogous to the preparation of polymer dispersion 10, except that the reaction temperature was 65° C. instead of 35° C.

The aqueous polymer dispersion obtained had a solids content of 14.7% by weight and a coagulum content of 1.5% by weight. The average particle size was found to be 264 nm.

### II.15 Polymer Dispersion 15

The preparation of polymer dispersion 15 was carried out in a manner fully analogous to the preparation of polymer dispersion 11, except that the reaction temperature was 65° C. instead of 35° C.

The aqueous polymer dispersion obtained had a solids content of 13.5% by weight and a coagulum content of 1.6% by weight. The average particle size was found to be 262 nm.

### II.16 Polymer Dispersion 16

The preparation of polymer dispersion 16 was carried out in a manner fully analogous to the preparation of polymer dispersion 12, except that the reaction temperature was 65° C. instead of 35° C. and the reaction time was only 1 hour.

The aqueous polymer dispersion obtained had a solids content of 13.4% by weight and a coagulum content of 0.1% by weight. The average particle size was found to be 268 nm.

### II.C1 Comparative Example 1

Comparative example 1 was carried out in a manner fully analogous to the preparation of polymer dispersion 1, except that 20.6 mg (0.023 mmol) of complex 13 were used instead of ruthenium complex 3.

The aqueous polymer dispersion obtained had a solids content of 0.9% by weight and a coagulum content of 1.1% by weight. The average particle size was found to be 441 nm.

### II.C2 Comparative Example 2

Comparative example 2 was carried out in a manner fully analogous to the preparation of polymer dispersion 1, except that the total amount of ruthenium complex 3 was taken up in 13.6 g of deionized water to form a suspension.

No aqueous polymer dispersion was obtained.

### II.C3 Comparative Example 3

Comparative example 3 was carried out in a manner fully analogous to the preparation of polymer dispersion 1, except that the total amount of ruthenium complex 3 was taken up in a solution comprising 6.8 g of deionized water and 6.8 g of methanol to form a suspension.

No aqueous polymer dispersion was obtained.

### II.C4 Comparative Example 4

Comparative example 4 was carried out in a manner fully analogous to the preparation of polymer dispersion 1, except that the total amount of ruthenium complex 3 was taken up in 13.6 g of methanol.

No aqueous polymer dispersion was obtained.

1. A process for producing an aqueous polymer dispersion by polymerization of at least one ethylenically unsaturated monomer MON in an aqueous medium in the presence of at least one dispersant DP, optionally an organic solvent OS which has a low solubility in water and at least one metal-carbene complex C of the general formula (I),
MX¹X²L¹L²L³[═CR¹R²] (I),
where
M is Os, Mo, W or Ru in the oxidation states +II, +III, +IV or +VI,
X¹, X² are each, independently of one another, halide, pseudohalide, alkoxide, acetate, sulfate, phosphate,
L¹, L², L³ are each, independently of one another, 1,3-bis(C₁-C₅-alkyl)imidazolidin-2-ylidene, 1,3-bis(aryl)imidazolidin-2-ylidene, 1,3-bis(2,4,6-trimethylphenyl)imidazolidin-2-ylidene, 1,3-bis(2,4,6-tri-C₁-C₅-alkylphenyl)imidazolidin-2-ylidene, 1,3-bis(2,4-diisopropylphenyl)imidazolidin-2-ylidene, 1,3-bis(2,4-di-C₁-C₅-alkylphenyl)imidazolidin-2-ylidene, 1,3-bis(2,6-diisopropylphenyl)-4,5-imidazolin-2-ylidene, 1,3-bis(2,6-diisopropylphenyl)imidazolidin-2-ylidene, 1,3-bis(2,4,6-tri-C₅-C₈-cycloalkylphenyl)imidazolidin-2-ylidene, 1,3-bis(C₁-C₅-alkyl)imidazolin-2-ylidene, 1,3-bis(aryl)imidazolin-2-ylidene, 1,3-bis(2,4,6-trimethylphenyl)imidazolin-2-ylidene, 1,3-bis(2,4,6-tri-C₁-C₅-alkylphenyl)imidazolin-2-ylidene, 1,3-bis(2,4-diisopropylphenyl)imidazolin-2-ylidene, 1,3-bis(2,4-di-C₁-C₅-alkylphenyl)imidazolin-2-ylidene, 1,3-bis(2,4,6-tri-C₅-C₈-cycloalkylphenyl)imidazolin-2-ylidene, 3-bromopyridine, 3-chloro-pyridine, 3-fluoropyridine, 4-dimethylaminopyridine, 3-C₁-C₅-alkyl-pyridine, di-C₁-C₂₀-alkyl ether, di-C₃-C₂₀-cycloalkyl ether, 2-isopropoxy-phenylmethylene, 2-isopropoxypyridine, triarylphosphine, tri-C₅-C₈-cycloalkylphosphine, tri-C₁-C₅-alkylphosphine or diaryl-C₁-C₅-alkyl-phosphine, and
R¹, R² are each, independently of one another, hydrogen, C₁-C₂₀ -alkyl, C₂-C₂₀-alkenyl, C₄-C₈-cycloalkenyl, C₂-C₂₀-alkynyl, aryl, indenyl, 2-isopropoxy-phenyl, 2-isopropoxy-5-(2,2,2-trifluoroacetamido)phenyl, C₁-C₂₀-alkoxyphenyl, C₁-C₂₀-alkoxyamino, C₁-C₂₀-alkoxy, C₁-C₂₀-alkoxy-carbonyl, C₂-C₂₀-alkenyloxy, C₂-C₂₀-alkynyloxy, aryloxy, C₁-C₂₀-alkyl-thio, arylthio, C₁-C₂₀-alkylsulfonyl, C₁-C₂₀-alkylsulfinyl or together form a radical [═CR³R⁴], where R³ and R⁴ are each, independently of one another, hydrogen, C₁-C₂₀-alkyl, C₂-C₂₀-alkenyl, C₂-C₂₀-alkynyl, aryl, indenyl, isopropoxyphenyl, C₁-C₂₀-alkoxyphenyl, C₁-C₂₀-alkoxyamino, C₁-C₂₀-alkoxy, C₁-C₂₀-alkoxycarbonyl, C₂-C₂₀-alkenyloxy, C₂-C₂₀-alkynyloxy, aryloxy, C₁-C₂₀-alkylthio, arylthio, C₁-C₂₀-alkylsulfonyl, C₁-C₂₀-alkylsulfinyl,
where
the alkyl radicals of the groups L¹, L², L³, R¹, R², R³ and R⁴ in general may optionally be substituted by 1, 2 or 3 groups selected from among C₁-C₅-alkyl, aryl, halogen, hydroxy, mercapto, C₁-C₅-alkoxy and C₁-C₅-alkoxycarbonyl, hydrazino, carboxy, carboxyamido, acetamido, amino, nitro, cyano, sulfamoyl, amidino, hydroxycarbamoyl, carbamoyl, phosphonamino, hydroxyphosphinoyl, phosphono, sulfino, sulfo, dithiocarboxy, thiocarboxy, furyl, pyridinyl, piperidinyl, furfuryl, pyrazolyl, isothiazolyl, pyrazinyl, pyrimidinyl, pyridazinyl, isoindolyl and indolyl, and the aryl radicals of the groups L¹, L², L³, R¹, R², R³ and R⁴ may optionally be substituted by 1, 2 or 3 groups selected from among C₁-C₅-alkyl, aryl, halogen, hydroxy, mercapto, C₁-C₅-alkoxy and C₁-C₅-alkoxycarbonyl, hydrazino, carboxy, carboxyamido, acetamido, amino, nitro, cyano, sulfamoyl, amidino, hydroxycarbamoyl, carbamoyl, phosphonamino, hydroxyphosphinoyl, phosphono, sulfino, sulfo, dithiocarboxy, thiocarboxy, furyl, pyridinyl, piperidinyl, furfuryl, pyrazolyl, isothiazolyl, pyrazinyl, pyrimidinyl, pyridazinyl, isoindolyl and indolyl,
with the proviso that at least one of the groups L¹, L², L³, R¹, R², R³ and R⁴ is substituted by at least one group selected from the group consisting of carboxylate (—CO₂Z), sulfonate (—SO₃Z), ammonium (—NABCD), phosphate (—PO₃Z), phosphonium (—PABCD), imidazolylium (-imidazolylAD), pyridylium (-pyridylAD), piperidylium (-piperidylABD), pyrylium (-pyryliumD), pyrazolylium (-pyrazolylAD), isothiazolylium (-isothiazolylAD), pyrazinylium (-pyrazinylAD), pyrimidinylium (-pyrimidinylAD) or pyridazinylium (-pyrazinylAD) which can be dissociated ionically in the aqueous reaction medium under polymerization conditions,
where
Z is a proton, an alkali metal cation or ammonium,
A, B, C are each, independently of one another, hydrogen, C₁-C₅-alkyl, aryl and
D is an anion,
or a methylene group in at least one of the C₅-C₈-cycloalkyl groups of the tri-C₅-C₈-cycloalkylphosphines L¹, L² and/or L³ is replaced by a secondary ammonium group (>NABD) and A, B and D are as defined above, wherein
a)
a1) at least part of the water,
a2) at least part of the at least one dispersant DP,
a3) at least part of the at least one ethylenically unsaturated monomer MON and
a4) optionally at least part of the organic solvent OS
a5) are placed in the form of an aqueous monomer macroemulsion having an average droplet diameter of ≧2 μm in a vessel, then
b) the monomer macroemulsion is converted with input of energy into a monomer miniemulsion having an average droplet diameter of ≦1500 nm and then
c) at the polymerization temperature,
c1) any remaining amount of the water,
c2) any remaining amount of the at least one dispersant DP,
c3) any remaining amount of the at least one monomer MON,
c4) any remaining amount of the organic solvent OS and
c5) the total amount of the metal-carbene complex C are added to the resulting monomer miniemulsion and the at least one monomer MON is polymerized to a monomer conversion of ≧80% by weight.

2. The process according to claim 1, wherein the at least one ethylenically unsaturated monomer MON is a monocyclic or polycyclic aliphatic olefin.

3. The process according to either claim 1 or 2, wherein the monomer MON is cis-cyclooctene, trans-cyclooctene and/or dicyclopentadiene.

4. The process according to any of claims 1 to 3, wherein the metal-carbene complex C is a dimethylammonium reaction product prepared from a metal-carbene complex selected from the group consisting of dichloro-1,3-bis(2,6-dimethyl-4-dimethylaminophenyl)imidazolidin-2-ylidenebis(4-dimethylamino-pyridine)benzylideneruthenium(II), dichloro-1,3-bis(2,6-dimethyl-4-dimethyl-aminophenyl)imidazolin-2-ylidenebis(4-dimethylaminopyridine)benzylideneruthenium(II), dichloro-1,3-bis(2,6-dimethyl-4-dimethylaminophenyl)imidazolidin-2-ylidenebis(4-dimethylaminopyridine)phenylthiomethyleneruthenium(II) and dichloro-1,3-bis(2,6-dimethyl-4-dimethylaminophenyl)imidazolin-2-ylidenebis(4-dimethylaminopyridine)phenylthiomethyleneruthenium(II).

5. The process according to any of claims 1 to 4, wherein the molar ratio of monomer MON to the metal-carbene complex C is ≧1000.

6. The process according to any of claims 1 to 5, wherein the organic solvent OS is selected from the group consisting of n-hexane, n-octane, n-decane, n-tetra-decane, n-hexadecane and the branched isomers thereof, benzene, toluene and ethylbenzene.

7. The process according to any of claims 1 to 6, wherein the total amount of the at least one dispersant DP is used in process step a2) and the total amount of the at least one monomer MON is used in process step a3).

8. The process according to any of claims 1 to 7, wherein a cationic and/or nonionic emulsifier is used as dispersant DP.

9. The process according to any of claims 1 to 8, wherein the polymerization temperature is ≧10 and ≦120° C.

10. The process according to any of claims 1 to 9, wherein the pH of the aqueous polymerization medium is ≦6.

11. The process according to any of claims 1 to 10, wherein monomer droplets having an average diameter of ≧50 and ≦1300 nm are produced in process step b).

12. The process according to any of claims 1 to 11, wherein ≧30 and ≦900 parts by weight of water are used per 100 parts by weight of monomers MON.

13. An aqueous polymer dispersion which can be obtained by a process according to any of claims 1 to 12.

14. A polymer powder which can be obtained by drying an aqueous polymer dispersion according to claim 13.

15. The use of an aqueous polymer dispersion according to claim 13 or a polymer powder according to claim 14 for producing adhesives, sealants, polymer plasters and renders, paper coatings, fiber nonwovens, paints and impact modifiers and also for the consolidation of sand, textile finishing, leather finishing or for modifying mineral binders and plastics.

16. A metal-carbene complex selected from the group consisting of dichloro-1,3-bis(2,6-dimethyl-4-dimethylaminophenyl)imidazolidin-2-ylidenebis(4-dimethyl-aminopyridine)benzylideneruthenium(II), dichloro-1,3-bis(2,6-dimethyl-4-dimethylaminophenypimidazolin-2-ylidenebis(4-dimethylaminopyridine)-benzylideneruthenium(II), dichloro-1,3-bis(2,6-dimethyl-4-dimethylaminophenyl)-imidazolidin-2-ylidenebis(4-dimethylaminopyridine)phenylthiomethyleneruthenium(II) and dichloro-1,3-bis(2,6-dimethyl-4-dimethylaminophenyl)-imidazolin-2-ylidenebis(4-dimethylaminopyridine)phenylthiomethyleneruthenium(II).
